(19) United States
(12) Patent Application Publication
(10) Pub. No.: US 2014/0320388 A1
(43) Pub. Date: Oct. 30, 2014

(54) STREAMING K-MEANS COMPUTATIONS

(71) Applicant: MICROSOFT CORPORATION, Redmond, WA (US)

(72) Inventors: Alessandro Forin, Bellevue, WA (US); Ken Eguro, Seattle, WA (US); Ray Bittner, Bothell, WA (US)

(73) Assignee: Microsoft Corporation, Redmond, WA (US)

(21) Appl. No.: 13/869,960

(22) Filed: Apr. 25, 2013

(51) Int. Cl. G06F 3/00

(52) U.S. Cl. CPC G06F 3/005
USPC 345/156

(57) ABSTRACT

A set of population data that includes a plurality of individual population data entities is obtained. Each of the individual population data entities in the obtained set is streamed to an array of a plurality of evaluation functions. The evaluation functions are configured to evaluate each entity to determine an acceptability of the entity for a current state of a candidate centroid value associated with the evaluation function. Acceptance of input data entities is terminated after a first accepting one of the evaluation functions accepts an entity, based on the determined acceptability and on a predetermined priority ordering of acceptance. The first accepting one of the evaluation functions, in the priority ordering, incorporates population data associated with the accepted entity into an aggregator that is local to the first accepting evaluation function.

### BACKGROUND

Cluster analysis, or clustering, typically involves grouping a set of entities in such a way that entities in the same group, or cluster, are more similar to each other than to those in other groups, or clusters. For example, clustering may be used for exploratory data mining, as well as for statistical data analysis used in many fields, including (at least) machine learning, pattern recognition, image analysis, information retrieval, and bioinformatics.

### SUMMARY

According to one general aspect, a system may include a streaming computational engine that may include a population data acquisition component configured to obtain a set of population data that includes a plurality of individual population data entities. A population data streaming component may be configured to initiate streaming of each of the individual population data entities in the obtained set to an array of a plurality of evaluation functions. Each of the evaluation functions is configured to evaluate the individual population data entity to determine an acceptability of the individual population data entity for a current state of a candidate centroid value associated with the evaluation function, with acceptance of each of the input data entities terminated after a first accepting one of the evaluation functions accepts the individual data entity, based on the determined acceptability and on a predetermined priority ordering of acceptance. The first accepting one of the evaluation functions, in the priority ordering, incorporates population data associated with the individual population data entity into an aggregator that is local to the first accepting one of the evaluation functions.

According to another aspect, a system may be configured to obtain a set of population data that includes a plurality of individual population data entities. The system may be configured to initiate streaming of each of the individual population data entities in the obtained set to an array of a plurality of evaluation functions. Each of the evaluation functions may be configured to evaluate the individual population data entity to determine an acceptability of the individual population data entity for a current state of a candidate centroid value associated with the evaluation function, with acceptance of each of the input data entities terminated after a first accepting one of the evaluation functions accepts the individual data entity, based on the determined acceptability and on a predetermined priority ordering of acceptance. The first accepting one of the evaluation functions, in the priority ordering, incorporates population data associated with the individual population data entity into an aggregator that is local to the first accepting one of the evaluation functions.

According to another aspect, a computer-readable storage medium may store instructions that, when executed by one or more processors, cause the one or more processors to obtain a set of population data that includes a plurality of individual population data entities. Further, the one or more processors may stream each of the individual population data entities in the obtained set to an array of a plurality of evaluation functions, each of the evaluation functions configured to evaluate the individual population data entity to determine an acceptability of the individual population data entity for a current state of a candidate centroid value associated with the evaluation function. Acceptance of each of the input data entities is terminated after a first accepting one of the evaluation functions accepts the individual data entity, based on the determined acceptability and on a predetermined priority ordering of acceptance. The first accepting one of the evaluation functions, in the priority ordering, incorporates population data associated with the individual population data entity into an aggregator that is local to the first accepting one of the evaluation functions.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. The details of one or more implementations are set forth in the accompanying drawings and the description below. Other features will be apparent from the description and drawings, and from the claims.

### DRAWINGS

FIG. 1 is a block diagram illustrating of an example system for streamed computations.

FIG. 2 illustrates an example application scenario associated with the system of FIG. 1.

FIG. 3 illustrates example states of an example candidate centroid.

FIG. 4 illustrates an example input filter.

FIG. 5 illustrates an example hardware pipeline.

FIG. 6 illustrates an example pipeline entry expansion.

FIG. 7 illustrates logic for an example parallel bin evaluator pipeline lane.

FIG. 8 illustrates an example accumulator memory structure and an example result of an access.

FIG. 9 illustrates an example architecture for the system of FIG. 1.

FIG. 10 illustrates an example array of candidate centroids.

FIG. 11 illustrates an example input probability map.

FIG. 12 illustrates an example representation of a body part map.

FIG. 13 illustrates an example result of noisy input.

FIG. 14 illustrates an example result skeleton for an individual.

FIGS. 15a-15c are a flowchart illustrating example operations of the system of FIG. 1.

FIG. 16 is a flowchart illustrating example operations of the system of FIG. 1.

FIGS. 17a-17b are a flowchart illustrating example operations of the system of FIG. 1.

### DETAILED DESCRIPTION

### I. Introduction

K-means clustering is a method of cluster analysis with a goal of partitioning n observations into k clusters in which each observation belongs to the cluster with the nearest mean. It is used widely in a variety of fields, from data mining to image processing. For example, as discussed further herein, it may be used in image processing, for tracking parts of images. For example, as part of a Skeletal Tracking vision pipeline it may be desirable to identify the centroids in a probability map in a three-dimensional (3D) coordinate system, in order to assign a specific location to a body part. Similarly to Skeletal Tracking, an example Hand Tracking application may obtain a KINECT depth map as input and determine the three joints of each finger, of each hand, plus palm, wrist, and forearm.

The clustering problem is NP-complete; however, efficient heuristic algorithms have been used, such as Lloyd's algorithm, and Mean-shift clustering. However, both of these algorithms involve multiple passes over the input data to produce a result, which affects performance, and limits scalability. For example, a variation over Mean-shift may be time-quadratic in the size of the input image. Further, the amount of temporary storage involved may run on the order of approximately twice the size of the input image(s) to compute its results.

For example, a KINECT technique may handle 31 body parts each for N players, resulting in 31*N image portions to be processed for each frame. For example, all N players may be represented in a single image (e.g., a frame). Conventional K-means techniques may process all of the image data once to establish a set of starting centroids, and then process the entire image again, against those starting centroids. This may be repeated until there are no further improvements in the locations of the centroids (i.e., conventionally, the entire image may be re-processed X times, where X is not dependent on the number of players or body parts). It may thus be desirable to use a single pass (or a sequential, streaming pass) over the input data, and use a smallest possible amount of temporary storage.

Among recent realizations of K-means in hardware, Lin et al., “K-Means Implementation on FPGA for High-Dimensional Data Using Triangle Inequality,” 22nd International Conference on Field Programmable Logic and Applications (FPL), Aug. 29-31, 2012, pp. 437-442, discusses targeting of data mining applications with relatively large datasets and high dimensionality. The approach is multi-pass but reduces the amount of computation involved by using triangle inequality, a simple geometry property applied to triples of centroids.

Additionally, Scott Bailie, et al., “Incremental Clustering Applied to Radar De-Interleaving: A Parameterized FPGA Implementation,” Proceedings of the ACM/SIGDA International Symposium on Field Programmable Gate Arrays (FPGA'12), February 2012, pp. 25-28, discusses an example technique which is incremental, and which may effectively perform the multiple passes of Lloyd's algorithm using a successive input data set (e.g., over successive frames). If the input data changes incrementally (which is the case for radar images), the algorithm may eventually converge and track the desired set of centroids.

The term “supervised” is used in this problem domain to indicate whether the number of classes, the target K of candidate centroids, and other parameters are predefined (supervised) or not (unsupervised). A semi-supervised solution defines some parameters statically and some dynamically. For example, the approach of Bailie, supra, defines statically the maximum size of a centroid (distance threshold) and the decay (fade cycle), and defines the number K dynamically.

For example, the maximum size of centroids as discussed in Bailie, supra, and the partitioning trees used therein may effectively divide the search space in fixed portions, similarly to example techniques discussed in Saegusa et al., “An FPGA Implementation of K-Means Clustering for color images based on Kd-Tree,” International Conference on Field Programmable Logic and Applications (FP '06), 28-30 Aug. 2006, pp. 1-6. In the pure streaming case, a fixed partition may become problematic, because a centroid that is accumulating points and changing its center may not cross a partition. In Bailie, supra, this is handled by letting the centroid fade away in the old partition and creating a new one in the new partition.

In Bailie, supra, and in Saegusa et al., supra, a centroid may not grow larger than any given fixed partition. However, in accordance with example techniques discussed herein, there may be significant size differences between, for example, a young far-away child and a big close-up adult. In accordance with example techniques discussed herein, a pure-streaming implementation of the k-means algorithm may be used which is semi-supervised (e.g., by specifying a maximum size of a centroid), but with no fixed division of the world space.

In accordance with example techniques discussed herein, an input data entity (e.g., a pixel) may be streamed to an array of evaluation functions (e.g., candidates), in order, for a particular target identifiable object (e.g., a particular body part, for a particular individual). For example, the candidates may include multiple centroid candidates that are associated with respective predefined body parts, for respective individuals.

In accordance with example techniques discussed herein, an evaluation function (e.g., a candidate) may accept the input data entity (e.g., by absorbing it into an aggregator local to the evaluation function), if the evaluation function is currently empty (e.g., has no currently accepted input data entities), or if the input data entity is determined to be within a predefined maximum distance of a current center associated with the evaluation function.

In accordance with example techniques discussed herein, input data entities may be individually streamed to the array of evaluation functions in parallel, and acceptance of each of the input data entities is terminated after a first one of the evaluation functions accepts the individual data entity, in accordance with an acceptance ordering that is based on a network priority order.

In accordance with example techniques discussed herein, input data entities may be individually streamed across the array of evaluation functions in a predetermined array order, with the streaming terminating when an evaluation function accepts the individual data entity.

One skilled in the art of data processing will appreciate that there may be many ways to accomplish the streamed computations discussed herein, without departing from the spirit of the discussion herein.

### II. Example Operating Environment

Features discussed herein are provided as example embodiments that may be implemented in many different ways that may be understood by one of skill in the art of data processing, without departing from the spirit of the discussion herein. Such features are to be construed only as example embodiment features, and are not intended to be construed as limiting to only those detailed descriptions.

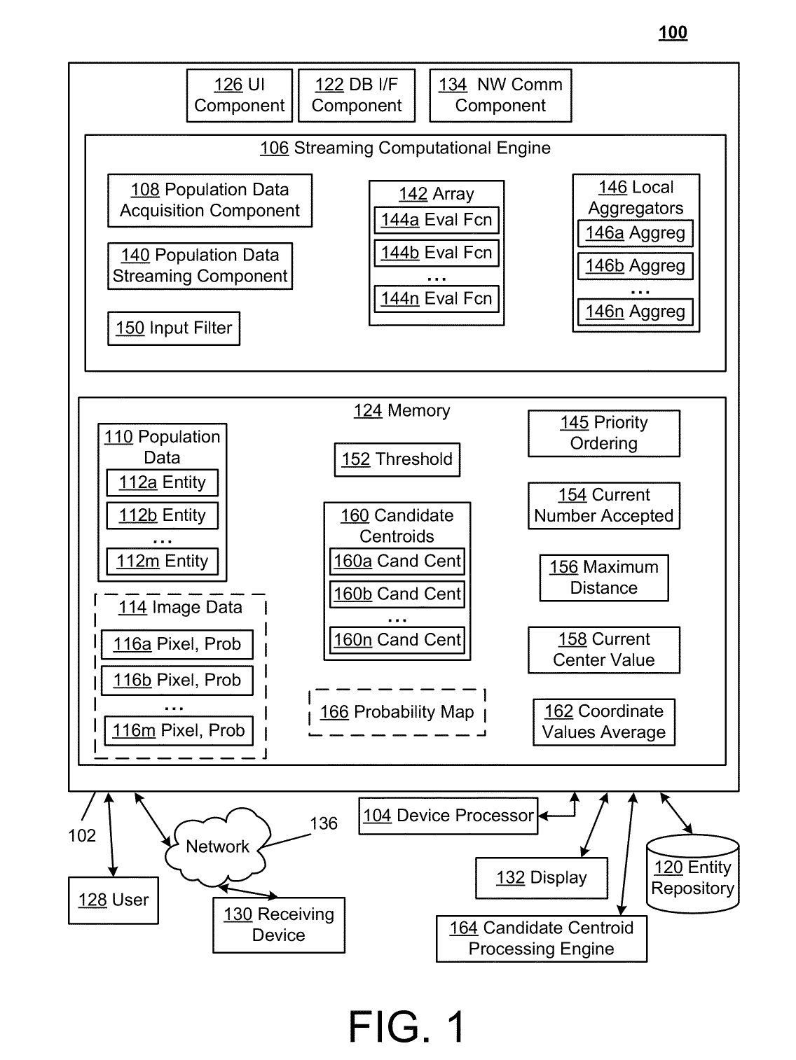

As further discussed herein, FIG. 1 is a block diagram of a system 100 for streamed k-means computations. One skilled in the art of data processing will appreciate that system 100 may be realized in hardware implementations, software implementations, or combinations thereof. As shown in FIG. 1, a system 100 may include a device 102 that includes at least one processor 104. The device 102 may include a streaming computational engine 106 that may include a population data acquisition component 108 that may be configured to obtain a set of population data 110 that includes a plurality of individual population data entities 112a, 112b, . . . , 112m. For example, the set of population data 110 may include a set of image data 114 that may include a plurality of pixels 116a, 116b, . . . , 116m, with associated weights. For example, the respective weights may indicate respective probabilities that respective pixels are associated with a particular part (e.g., a body part such as a hand, or hand joint).

According to an example embodiment, the streaming computational engine 106, or one or more portions thereof, may include executable instructions that may be stored on a tangible computer-readable storage medium, as discussed below. According to an example embodiment, the computer-readable storage medium may include any number of storage devices, and any number of storage media types, including distributed devices.

In this context, a “processor” may include a single processor or multiple processors configured to process instructions associated with a processing system. A processor may thus include one or more processors processing instructions in parallel and/or in a distributed manner. Although the device processor 104 is depicted as external to the streaming computational engine 106 in FIG. 1, one skilled in the art of data processing will appreciate that the device processor 104 may be implemented as a single component, and/or as distributed units which may be located internally or externally to the streaming computational engine 106, and/or any of its elements.

For example, the system 100 may include one or more processors 104. For example, the system 100 may include at least one tangible computer-readable storage medium storing instructions executable by the one or more processors 104, the executable instructions configured to cause at least one data processing apparatus to perform operations associated with various example components included in the system 100, as discussed herein. For example, the one or more processors 104 may be included in the at least one data processing apparatus. One skilled in the art of data processing will understand that there are many configurations of processors and data processing apparatuses that may be configured in accordance with the discussion herein, without departing from the spirit of such discussion.

In this context, a “component” may refer to instructions or hardware that may be configured to perform certain operations. Such instructions may be included within component groups of instructions, or may be distributed over more than one group. For example, some instructions associated with operations of a first component may be included in a group of instructions associated with operations of a second component (or more components). For example, a “component” herein may refer to a type of functionality that may be implemented by instructions that may be located in a single entity, or may be spread or distributed over multiple entities, and may overlap with instructions and/or hardware associated with other components.

According to an example embodiment, the streaming computational engine 106 may be implemented in association with one or more user devices. For example, the streaming computational engine 106 may communicate with a server, as discussed further below.

For example, an entity repository 120 may include one or more databases, and may be accessed via a database interface component 122. One skilled in the art of data processing will appreciate that there are many techniques for storing repository information discussed herein, such as various types of database configurations (e.g., relational databases, hierarchical databases, distributed databases) and non-database configurations.

According to an example embodiment, the streaming computational engine 106 may include a memory 124 that may store the set of population data 110. In this context, a “memory” may include a single memory device or multiple memory devices configured to store data and/or instructions. Further, the memory 124 may span multiple distributed storage devices. Further, the memory 124 maybe distributed among a plurality of processors.

According to an example embodiment, a user interface component 126 may manage communications between a user 128 and the streaming computational engine 106. The user 128 may be associated with a receiving device 130 that may be associated with a display 132 and other input/output devices. For example, the display 132 may be configured to communicate with the receiving device 130, via internal device bus communications, or via at least one network connection.

According to example embodiments, the display 132 may be implemented as a flat screen display, a print form of display, a two-dimensional display, a three-dimensional display, a static display, a moving display, sensory displays such as tactile output, audio output, and any other form of output for communicating with a user (e.g., the user 128).

According to an example embodiment, the streaming computational engine 106 may include a network communication component 134 that may manage network communication between the streaming computational engine 106 and other entities that may communicate with the streaming computational engine 106 via at least one network 136. For example, the network 136 may include at least one of the Internet, at least one wireless network, or at least one wired network. For example, the network 136 may include a cellular network, a radio network, or any type of network that may support transmission of data for the streaming computational engine 106. For example, the network communication component 134 may manage network communications between the streaming computational engine 106 and the receiving device 130. For example, the network communication component 134 may manage network communication between the user interface component 126 and the receiving device 130.

A population data streaming component 140 may be configured to initiate streaming of each of the individual population data entities 112a, 112b, . . . , 112m in the obtained set to an array 142 of a plurality of evaluation functions 144a, 144b, . . . , 144n, each of the evaluation functions 144a, 144b, . . . , 144n configured to evaluate the individual population data entity 112a, 112b, . . . , 112m to determine an acceptability of the each individual population data entity 112 for a current state of a candidate centroid value 160a, 160b, . . . , 160n associated with the each evaluation function 144a, 144b, . . . , 144n, with acceptance of each of the input data entities terminated after a first accepting one of the evaluation functions 144a, 144b, . . . , 144n accepts the individual data entity 112a, 112b, . . . , 112m, based on the determined acceptability and on a predetermined priority ordering 145 of acceptance, the first accepting one of the evaluation functions 144a, 144b, . . . , 144n, in the priority ordering 145, incorporating population data associated with the individual population data entity 112a, 112b, . . . , 112m into an aggregator 146a, 146b, . . . , 146n that is local to the first accepting one of the evaluation functions 144b, . . . , 144n.

For example, an input filter 150 may be configured to eliminate at least a portion of the plurality of individual population data entities 112a, 112b, . . . , 112m prior to the streaming of the population data streaming component 140, the eliminating based on a comparison of a predetermined threshold value 152 with a weight value associated with the population data entity 112a, 112b, . . . , 112m. For example, the input filter 150 may compare the threshold value 152 with a probability that a particular pixel 116a, 116b, . . . , 116m is associated with a predetermined part (e.g., a body part).

For example, each of the evaluation functions 144a, 144b, . . . , 144n may be configured to accept the individual population data entity 112a, 112b, . . . , 112m if a current number 154 of accepted individual population data entities 112a, 112b, . . . , 112m associated with the each of the evaluation functions 144a, 144b, . . . , 144n is zero for the obtained set of population data. For example, each of the evaluation functions 144a, 144b, . . . , 144n may accept the each individual population data entity 112a, 112b, . . . , 112m based on the each evaluation function 144a, 144b, . . . , 144n determining that the each individual population data entity 112a, 112b, . . . , 112m is within a maximum distance 156 of a current center value 158 associated with the respective each evaluation function 144a, 144b, . . . , 144n, if a current number 154 of accepted individual population data entities 112a, 112b, . . . , 112m associated with the each of the evaluation functions 144a, 144b, . . . , 144n is non-zero, for the obtained set of population data 110.

For example, the population data streaming component 140 may be configured to initiate sequential streaming of each of the individual population data entities 112a, 112b, . . . , 112m in the obtained set to the array 142 of a plurality of evaluation functions 144a, 144b, . . . , 144n, in parallel.

For example, the population data streaming component 140 may be configured to initiate sequential streaming of each of the individual population data entities 112a, 112b, . . . , 112m in the obtained set to the array 142 of a plurality of evaluation functions 144a, 144b, . . . , 144n, wherein the plurality of evaluation functions 144a, 144b, . . . , 144n are configured in an array ordering such that a first visited one of the evaluation functions 144a, 144b, . . . , 144n, in the array ordering, that accepts the each individual population data entity 112a, 112b, . . . , 112m incorporates the population data associated with the each individual population data entity 112a, 112b, . . . , 112m into the aggregator 146a, 146b, . . . , 146n that is local to the first visited one, terminating further streaming of the accepted each individual population data entity 112a, 112b, . . . , 112m to other evaluation functions 144a, 144b, . . . , 144n included in the array 142, that are arranged after the first visited one, in the array ordering.

For example, each of the evaluation functions 144a, 144b, . . . , 144n may be configured to forward the each individual population data entity 112a, 112b, . . . , 112m to a next respective evaluation function 144a, 144b, . . . , 144n, that is next in the array ordering, after the each evaluation function 144a, 144b, . . . , 144n in the array ordering, if the each evaluation function 144a, 144b, . . . , 144n fails to accept the each individual population data entity 112a, 112b, . . . , 112m.

For example, each of the evaluation functions 144a, 144b, . . . , 144n may be configured to determine a respective candidate centroid 160a, 160b, . . . , 160n associated with a cluster of individual population data entities 112a, 112b, . . . , 112m from the set of population data 110.

For example, each of the evaluation functions 144a, 144b, . . . , 144n may be configured to determine the respective candidate centroid 160a, 160b, . . . , 160n based on generating an average of geometric coordinate values 162 that are associated with a respective current subset of individual population data entities 112a, 112b, . . . , 112m that have been accepted by the each evaluation function 144a, 144b, . . . , 144n for a current obtained set of population data 110. For example, accumulative results of the respective aggregators that are local to the respective evaluation functions in the array may approximate k-means clustering of the population data using single pass streaming over the population data.

For example, the plurality of evaluation functions 144a, 144b, . . . , 144n may be configured to initiate streaming of at least a portion of the respective candidate centroids 160a, 160b, . . . , 160n to a candidate centroid processing engine 164, after a last individual population data entity 112a, 112b, . . . , 112m from the obtained set of population data 110 is streamed from the population data streaming component 140.

For example, each of the evaluation functions 144a, 144b, . . . , 144n may be configured to reset the respective candidate centroid 160a, 160b, . . . , 160n associated with the respective each evaluation function 144a, 144b, . . . , 144n, after the initiating of the streaming of at least a portion of the respective candidate centroids 160a, 160b, . . . , 160n to the candidate centroid processing engine 164.

For example, the obtained set of population data 110 may represent image data 114 associated with a single frame, wherein the image data 114 includes a plurality of pixels and respective probabilities 116a, 116b, . . . , 116m associated with each of the pixels indicating a probability that the each pixel is associated with a predefined body part. For example, the obtained set of population data 110 may represent one or more probability maps 166 associated with one or more respective predefined parts.

For example, the array 142 of the plurality of evaluation functions 144a, 144b, . . . , 144n may include a first array of a first plurality of evaluation functions 144a, 144b, . . . , 144n that are configured to determine a first plurality of candidate centroids 160a, 160b, . . . , 160n that are associated with a current geometric location of the predefined body part.

For example, the population data streaming component 140 may be configured to initiate the streaming of the each of the individual population data entities 112a, 112b, . . . , 112m in a sequential scan line order that is associated with receiving the image data 114.

In accordance with example techniques discussed herein, an algorithm may be defined as a function from a set of pairs I={Sample, Probability} into a set of pairs O={Mean, Probability}, where Sample and Mean are from the same domain Rⁿ (an ordered set of real numbers, e.g., coordinates in an n-dimensional space) and Probability is a real number in the [0 . . . 1] interval. For example, each Mean may be determined as an arithmetic average of the Samples in some subset C of the input set I, and the corresponding Probability is the average probability of the input set C. For example, a goal of the function may include computing the set O with the minimum cardinality and the minimum standard deviation.

Some variations of the algorithm may keep memory, and may thus no longer be a true mathematical function. In this case, an ordered sequence of input sets Iₛ may be defined, resulting into an ordered sequence Oₛ. For example, the goal may remain the same.

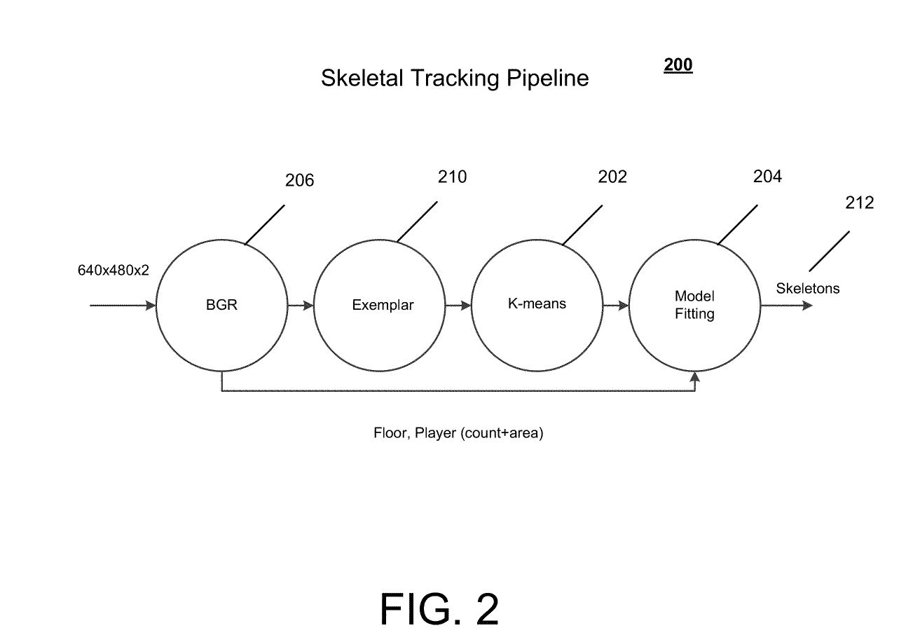

FIG. 2 illustrates an example application scenario associated with the system of FIG. 1. For example, as part of a Skeletal Tracking pipeline 200, K-means 202 may be used to compute the most likely candidate locations for each individual's (e.g., a game player, of multiple game players) body part. For example, a candidate list may then be passed to an example Model Fitting stage 204 that may make a final selection (from the candidate list) based on a variety of heuristics and trend data. For example, a hardware realization of the pipeline may advantageously reduce the power consumption and therefore enable scenarios such as mobile and embedded uses.

As clarification of the term “streaming,” an example format in which the input data may be presented to an example algorithm is considered. If the example algorithm can access every input pair at random, and as many times as desired, then the algorithm is not a streaming one. For example, an algorithm may be “streaming” if it accepts the input pairs as they are presented to it, and may not request to see them again. For example, a “sequential streaming algorithm” may involve input pairs that are ordered in a sequence (e.g., presenting the pixels in a scan-line order). For example, a pure functional streaming algorithm may compute the same result independently of the order the data is received. For example, a “procedural streaming algorithm” may compute similar but slightly different results dependent on the order the data is received.

In accordance with an example embodiment, one or more example techniques discussed herein may be streaming, non-sequential, and procedural.

As shown in the example scenario of FIG. 2, a background removal (BGR) stage 206 may remove background noise.

As shown in the example scenario of FIG. 2, an Exemplar stage 210 that precedes K-means 202 may be a producer of the input data for K-means 202. For example, if the K-means stage 202 is not streaming, the pixels may be stored in memory, either on or off chip. For example, if the K-means stage 202 is streaming, it may be possible to immediately and directly feed forward each pixel as it is produced. For example, if the K-means stage 202 is streaming sequential, it may be expected that the Exemplar stage 210 will ensure the order. For example, the Model Fitting stage 204 may refine the location of the body parts, to determine skeletons 212.

In accordance with an example technique, an example realization may be a streaming functional one, because it places a least amount of restriction on the previous stage. In accordance with an example technique, a streaming rocedural algorithm may also be used, if it creates only small differences in the results when ordering the input data in different ways.

In accordance with example techniques discussed herein, input Samples may be representative of a depth-map. For example, the input Samples may include triples {x,y,z} of coordinates. One skilled in the art of data processing will appreciate that any type of coordinate system may be used. For example, the coordinate system may include “world space,” wherein each pixel may be placed in a 1:1 correspondence to the real world, for example, measuring in millimeters and placing the origin at the focal center of a depth sensor. For example, the coordinate system may include “screen space.” where pixels may be placed on a photographic two-dimensional (2D) picture (e.g., the x,y are the coordinates in this photo, and the intensity Z is the distance from the depth sensor). For example, Probability may be in the [0 . . . 1] range defined above. A summary description of an example algorithm may be illustrated as shown in Algorithm 1:

Algorithm 1
Example Streamed Clustering Algorithm (body parts)

| | |
|---|---|
| 1 | Centroid candidates may be reset at the start of each frame by setting |
| | their population to zero. |
| 2 | The Input Filter may eliminate pixels by thresholding their |
| | probabilities (the threshold value may be adaptive). |
| 3 | A pixel is streamed to all candidates (in order) for this body part, |
| | for this player. |
| 4 | A centroid candidate with population equal to zero absorbs the pixel |
| | by setting its center to the pixel's coordinates and sets population |
| | to one (an additional bonus may be added to a pixel with a very |
| | high probability by incrementing the population by more than one). |
| | The pixel is no longer forwarded in this case. |
| 5 | A centroid candidate with a non-zero population tests if the pixel is |
| | within a maximum distance of its current center. In the negative case, |
| | the centroid forwards the pixel to the next centroid. In the positive |
| | case, the centroid does not forward the pixel and absorbs it by |
| | incrementing the population (possibly with a bonus), and |
| | re-evaluates the center, averaging in the new pixel. |
| 6 | At the end of the frame, the candidates with a non-zero population are |
| | streamed out of the centroid unit (e.g., to perform some post- |
| | processing, remove too small centroids, or those with low probability, |
| | merge candidates that have moved too close to each other, sort, using |
| | the population, the average probability, or a combination thereof). |

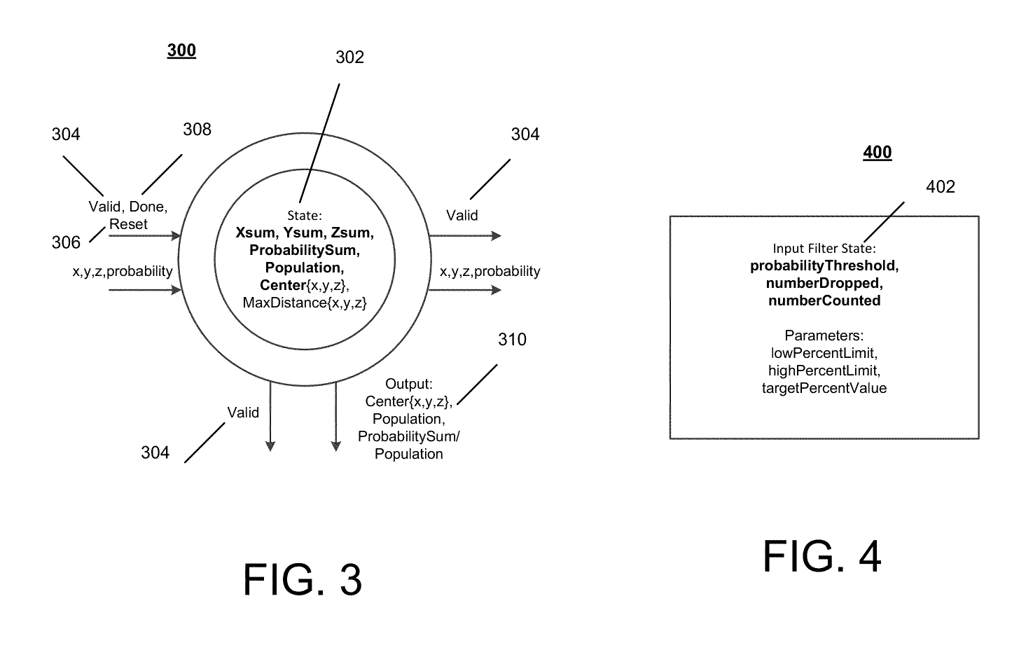

As shown in FIG. 3, each candidate centroid 300 may hold example states 302 as shown below, where bold fields may denote variables, and non-bold fields may denote constants, which may be indicted as:

1) Xsum, Ysum, Zsum—Sum of the values of coordinates for the pixels absorbed so far.

2) ProbabilitySum—Sum of the probabilities for those pixels

3) Population—Count of the pixels absorbed

4) Center{x,y,z}—Pre-computed average, for quick access. Each value is the corresponding Sum divided by population

5) MaxDistance{x,y,z}—Parameter defining a bounding box for absorbing pixels.

As shown in FIG. 3, an example Valid signal 304 may indicate a new pixel is streamed in/out of a centroid candidate 300. For example, Reset 306 may be asserted in between frames. For example, Done 308 may be used to stream results 310 at the end of a frame.

One skilled in the art of data processing will appreciate that other implementations are possible, and that they may use different states and/or variables. For example, instead of an exact mean, in some applications, user may use a running average, which may use less state, at the expense of precision. For example, the Center may be computed on-demand; however, it may also be recomputed in parallel as part of the update to the Sum, thereby reducing latency. For example, the distance computation may also be subject to variations. For example, geometric distance may be used, as well as Manhattan distance (or any other “distance” or “similarity” metric). According to an example embodiment, a box may be used in lieu of a sphere, which may involve more multipliers in hardware (however, spheres may also be used).

In accordance with an example technique discussed herein, the Population may be zeroed on Reset, and the remaining fields may be recomputed. For example, upon Reset, the state may not be cleared completely, but the previous center may be maintained as a first valid pixel, thus, effectively seeding the next frame with the results for the current one. For example, ProbabilitySum may be divided by Population, Center may be copied to XYZSum, and the population count may be reduced to one.

In accordance with an example body parts application, MaxDistance may be defined statically, with different values for different body parts. For example, a variable may also be used that adapts to the input stream. For example, the average body sizes may be identified in the Model Fitting stage 204, and MaxDistance may be scaled accordingly (e.g., advantageously generating a smaller number of candidates, with advantageous precision). For example, a local decision procedure may use the number of candidates and their distances (e.g., “Was a large number of candidates merged in the post-processing phase?”), and may adjust MaxDistance to reduce the number of merges.

As shown in FIG. 4, an example Input Filter 400 holds an example state, which may be indicated as:

1) probabilityThreshold—Pixels with a probability less than this value are discarded

2) numberDropped—How many pixels have been discarded in this frame

3) numberCounted—How many pixels were seen

4) lowPercentLimit—Minimum for the number of pixels kept before the probabilityThreshold is reduced

5) highPercentLimit—Maximum for the number of pixels kept before the probabilityThreshold is increased

6) targetPercent—Optimum operational value for pixels kept

7) initialThreshold—Initial value for probabilityThreshold

For example, the input filter 400 may adapt its probabilityThreshold to ensure that the number of pixels streamed is within a low/high percent of the numberCounted.

For example, on Reset, the probabilityThreshold may be recomputed as illustrated in Algorithm 2 below, and then numberDropped/Counted may be reset to zero.

Algorithm 2
Example probabilityThreshold Algorithm

| | |
|---|---|
| 1 | Compute percentKept as the ratio numberKept (which is |
| | numberCounted less numberDropped) over numberCounted. |
| 2 | If percentKept is within the low/highPercentLimit no adjustment is |
| | involved, this procedure ends. |
| 3 | Compute targetThreshold by multiplying the current |
| | probabilityThreshold by the ratio percentKept over |
| | targetPercent, ceiling to 1. |
| 4 | Compute the newThreshold as the midpoint between the current |
| | probabilityThreshold and targetThreshold. |
| 5 | Ceil newThreshold not to be greater than initialThreshold. |
| 6 | Assign to probabilityThreshold the newThreshold. |

One skilled in the art of data processing will appreciate that other schemes are possible, depending on the application scenario, with potential tradeoffs between responsiveness and smoothness. For example, applying a large change to the threshold may provide faster adaptation, but may generate ringing oscillations. For example, smoothing out the changes over multiple frames may keep the centroid from jumping around, but may involve taking a few frames before a desired level of accuracy is reached. For example, steps 4 and 5 of Algorithm 2 above may involve this tradeoff.

For example, the “*Percent*” parameters shown above may be constants, for example at 15%, 40%, and 30%, respectively. The precise values may depend on the amount of “noise” in the input stream (e.g., more noise may be expected with higher percentages). For example, the values may also be adjusted dynamically, based on other contextual information. For example, the initialThreshold value may also be determined as application specific.

In accordance with an example embodiment, a constant probabilityThreshold may be used, with no adaptation. In accordance with an example embodiment, Probabilities may be eliminated, with no input filter.

Since a centroid candidate stops forwarding a pixel that it has absorbed (e.g., accepted), the order in which the candidates see a new pixel may affect the result. Effectively, when a new pixel is created, an initial claim is laid to a volume around the new center equal to maxDistance. The center may later move, but may become heavier as more pixels are absorbed. For example, an upper bound on the maximum movement may be indicated as the sum of the Harmonic series

ΣⱼMaxDistance/ⱼ, (1)

which is equal to MaxDistance multiplied by the natural logarithm of N (number of pixels absorbed), plus the Euler-Mascheroni constant 0.5772156649, minus one. For example, for 19,200 pixels this is approximately 9 times MaxDistance. For example, this scenario may occur if pixels are all maxDistance apart from the current center, and always in the same direction, which may not occur, given the depth image boundaries. For example, for 10 pixels, all aligned and at the same maxDistance, the movement may be approximately 1.9×. Nonetheless, that the order in which pixels are presented to the algorithm affects the final results.

In accordance with an example technique discussed herein, a pixel that reaches an un-initialized candidate may set it as a new seed for the K-means algorithm. For example, in software, a new candidate may be allocated. However, in hardware, there may be a hard limit to how many candidates may be created, after which there is an overflow. One example approach in handling overflow is to experiment with a large sample of the input data and define a number large enough to avoid overflow. For example, too many candidates may be indicative of a very noisy input image, since in many cases it may be expected that one true centroid may be determined, with everything else determined as noise. In other cases, the number of expected results may be higher than one, but still predictable and the number of candidates may be sized accordingly.

Evaluating the Distance of a pixel from the center is a performance and area consideration for hardware. One example distance formulation involves computing the square root of the squared sums of the differences between pixel and center. For example, for three coordinates, that distance formulation may involve three adders, three multipliers, three more adders, a square root, and another adder for the final comparison. Another example formulation may use a bounding box rather than a sphere, which may involve three adders for the comparisons. Further, the three coordinates may compute in parallel with a simple AND gate at the end.

For an example operation in screen space, the bounding box may be scaled along the X and Y coordinates according to the Z value of the center. An example comparison is between Distance(Pixel,Center) and MaxDistance/Center.z, which involves a division. However, if the comparison is rewritten as

Center.z*Distance(Pixel,Center)<=MaxDistance, (2)

a multiplier and a comparator may be used advantageously.

For example, a division may also be involved to recompute the Center as Sum/Population. However, that division may be avoided by rewriting the comparison as

ZSum*Distance(Pixel,Center)<=MaxDistance*Population, (3)

which involve a multiplier instead, albeit with a larger number of bits. Each integer division performed for the center may truncate and lose precision. Thus, this optimization may therefore not only reduce latency, but may advantageously provide precision as well.

For example, when computing the center, a direct arithmetic mean may be used, or the probabilities may be incorporated to compute a weighted mean. In the first case, the coordinates may be added as in XSum+=Pixel.x. In the second case, an addition may be performed as XSum+=(Pixel.x*Probability). For example, a weighted mean option may be used in many cases, as appropriate.

One skilled in the art of data processing will appreciate that there are other ways to advantageously use the probability, to determine a more advantageous result. For example, more importance may be applied to pixels with the highest degree of confidence. For example, this may move the centroid in their direction, and/or provide more weight to a high confidence area over a lower confidence but possibly larger area. For example, this may be performed in hardware by counting the determined “exceptionally good” pixel N times, where N is a power of two (which may involve only shifts). As another example, one candidate slot may be reserved for the highest probability pixels.

As discussed above, candidate centroids may move around from their initial seed position in unpredictable ways. For example, a 2*MaxDistance bound may indicate that there is a probability that two candidates will overlap, and it may be desirable to merge them at the end of the processing of one frame. For example, a test for merging two candidates may be the same, or similar, as that for a new pixel, so that (now idle) module may be reused by feeding it with the Center of another centroid. For example, merging may thus be realized with a small set of multiplexers and a state machine. For example, as the final results are streamed out of the various centroid units, those that captured too few pixels may be trimmed, provided that at least one result is generated.

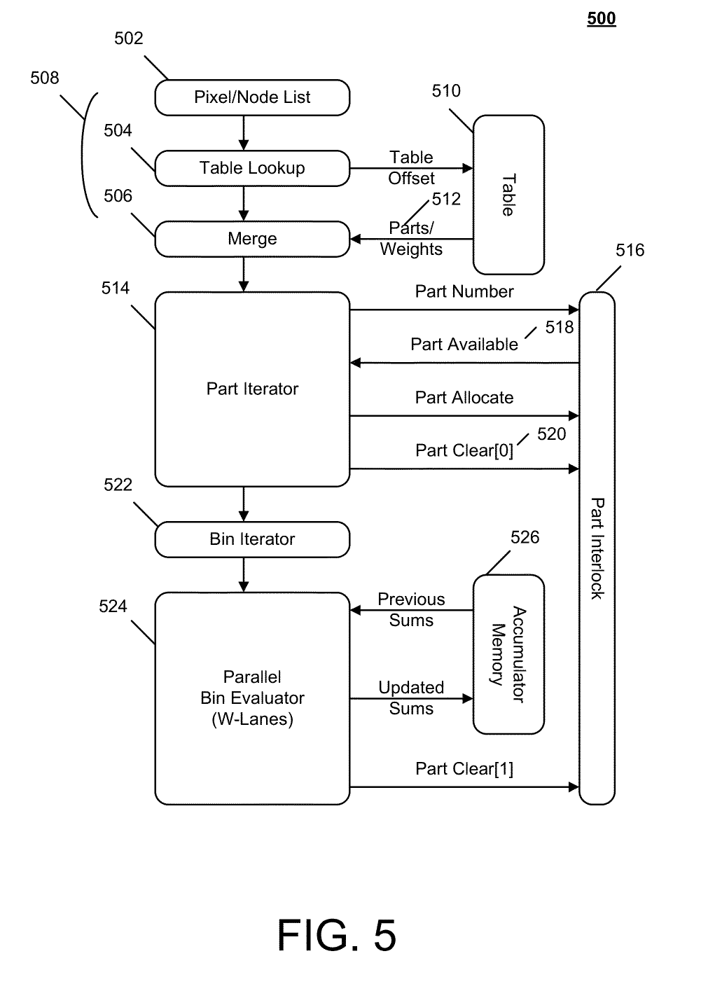

FIG. 5 illustrates an example high level hardware pipeline 500, in accordance with example techniques discussed herein. For example, the pipeline 500 may be viewed as a set of three nested for loops that iterate over pixels, parts and bins, respectively. A Pixel List 502, Table Lookup 504, and Merge 506 operations form the outer pixel loop 508.

As shown in the example of FIG. 5, each pixel in the list 502 has an associated table entry stored in a table 510. The table entry may include a list of predicted candidate parts and weights 512 for that pixel. Therefore, a first step of processing may involve fetching that table node from the table 510 (e.g., double data rate (DDR) memory). After that, a merge operation (506) may join the pixel data with its associated table entry.

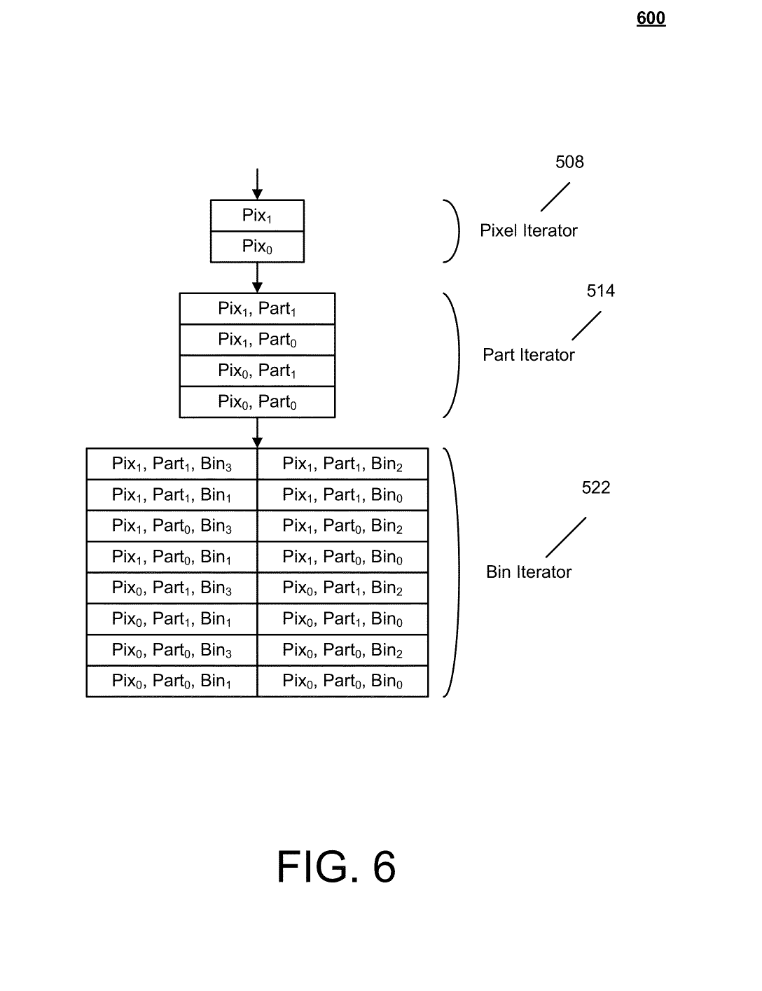

The merged pixel information may pass to a Part Iterator 514, where it may be expanded into multiple pipeline entries, one for each candidate pixel part. Up to this point, each pixel occupied a single pipeline timeslot (stage), but the Part Iterator 514 may expand each pixel by internally creating a pipeline entry for every candidate part, as shown in FIG. 6, which illustrates an example pipeline entry expansion for two pixels, two parts, four bins, and W=2.

The creation of these new pixel/part entries is gated by a Part Interlock unit 516. In the larger framework of the algorithm, the addition of a pixel to a centroid for a particular part may include a read/modify/write operation. Thus, the pipeline may provide exclusive access to the accumulators for each part for as long as that part is active in the pipeline. Therefore, before the Part Iterator 514 allows a pixel/part entry to proceed, it may send the part number to the Part Interlock unit 516. The Part Interlock unit 516 may check to determine whether that part is active in the remainder of the pipeline. If that part is already active, a Part Available signal 518 will not be asserted and the pipeline will stall waiting until the previous pixel/part entry using that part exits the pipeline. If the part is not already active in the pipeline, the Part Available signal 518 will be asserted and the Part Iterator 514 may create a new pipeline entry for that pixel/part.

A later stage within the Part Iterator 514 then checks the pixel/part entry for additional criteria. For example, that criterion may include a comparison of each part's weight against a threshold. Each part whose weight satisfies the threshold moves on through the pipeline as a new entry. If the pixel/part entry's weight does not meet the threshold, a Part Clear[0] 520 signal is asserted, freeing that part in the Part Interlock unit 516, and that pixel/part entry is dropped from the pipeline.

Once the filtered pixel/part entries have been cleared through the Part Iterator 514, they enter a Bin Iterator 522. In the Bin Iterator 522, each pixel/part entry is expanded again into a set of parallelized entries that accommodate all active bins for that pixel/part pair. In this example implementation, a maximum number of bins (centroids) per part is a parameter K. Another parameter W may determine the number of bins (centroids) that are evaluated in parallel. For example, W may allow the design to be expanded further for more advantageous execution at the expense of hardware resources, or contracted, resulting in slower execution with fewer hardware resources. Thus, if the part for a pixel/part entry has a maximum number of centroids K, then the maximum number of pixel/part/bin entries that is created for it by the Bin Iterator 522 is K/W.

As an example optimization, a number of pixel/part/bin entries that are created may be less than K/W because the Bin Iterator 522 may keep track of the number of previously occupied bins (centroids) for that part and may only issue enough pixel/part/bin entries to cover that many bins, plus one (the memory that stores the number of bins used per part is not shown in FIG. 5). The extra bin slot is sent to provide for a pixel that may not fall into any of the pre-existing bins, and so a new centroid may be created in the empty bin. In accordance with example techniques discussed herein, several empty bin slots may be included, as W bins may be issued in parallel, as for example, in a case where K=8, W=4 and the number of currently occupied bins is 4. The additional bin that is added to provide for the existence of an empty slot may generate an entire pixel/part/bin entry with 4 empty bin slots. If all K bins have already been occupied, the empty bin rule may be ignored and no additional bins may be generated. For example, supporting multiple bins may involve a more complex memory organization.

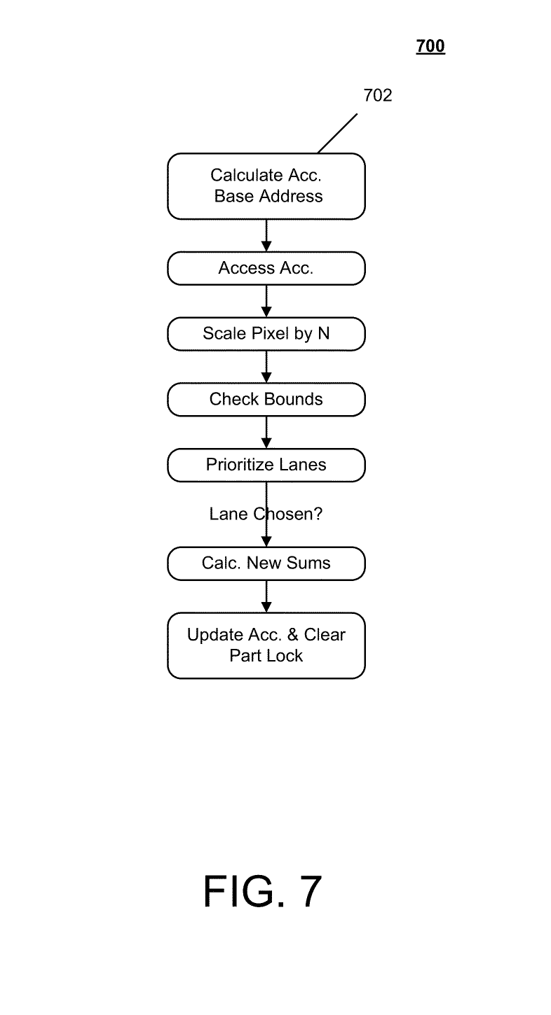

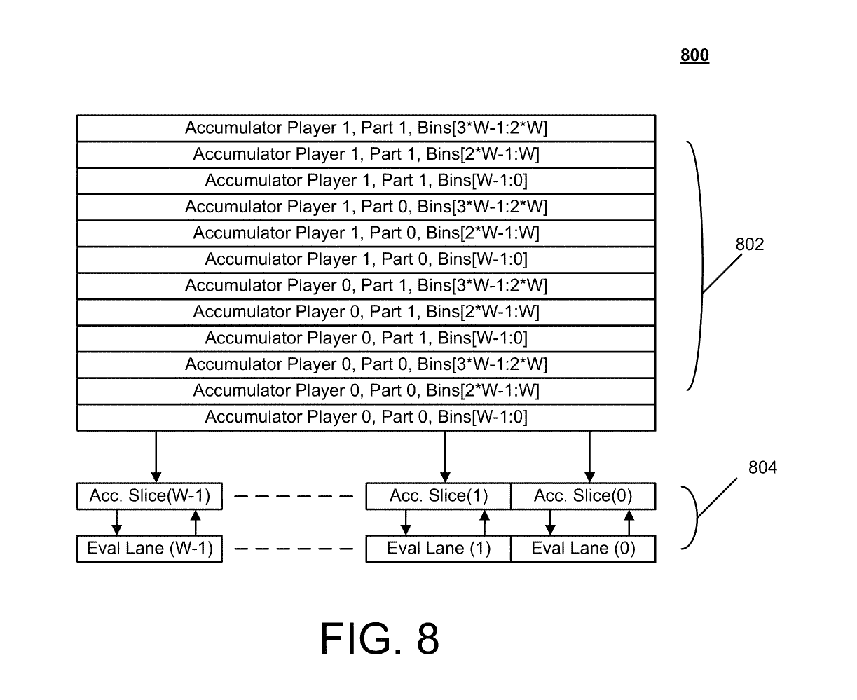

For example, the Bin Iterator 522 may feed final pixel/part/bin expansions into a Parallel Bin Evaluator 524, as further shown in FIG. 7. Within this unit, the part and bin values are used to compute the address (702) of the associated bin entries in an Accumulator Memory 526. The upper part of FIG. 8 shows an example memory structure 802 itself, with the result of an access (804) at the bottom. W sets of accumulator registers are fetched with a single access, corresponding to the W parallel evaluation lanes in the Parallel Bin Evaluator 524. Each of the W parallel memory slices includes all of the information needed to perform the test to determine whether the pixel should be placed in that bin, as well as the bin specific fields that may be updated in the event that a particular bin passes the test. For example, these fields may be zeroed out before each pixel set, indicating that all bins are empty.

After fetching an appropriate Accumulator Memory 526 entry, all of the parallel bins advance through the Parallel Bin Evaluator 524 pipeline to example bin testing stages. As discussed above, three example criteria that may be checked in the test for a pixel's inclusion in a particular bin may include:

Distance(Px,Cx)≦dxMax (4)

Distance(Py,Cy)≦dyMax (5)

Distance(Pz,Cz)≦dzMax (6)

where Px, Py, Pz denote the x,y,z coordinates of the candidate pixel, and Cx, Cy, Cz denote the centroid coordinate of a particular bin. dxMax, dyMax and dzMax denote parameters that may be set depending on an example size of a given part and may be different for each type of part. It may be advantageous to avoid the use of division to compute the Distance( ) functions, as dividers may involve long evaluation latencies, may not pipeline well, and may be hardware resource hungry. Thus, for example, these tests may be rewritten to avoid the use of division. For example,

$$\begin{matrix}Distance ( Px , Cx ) = \vert Px - Cx \vert \\ = \vert Px - \frac{Sum ( all {x}^{′} s )}{N} \vert\end{matrix} \qquad ( 7 )$$

where N denotes the total number of pixels already assigned to that bin, and “all x's” denotes the x coordinates of the pixels that have been assigned to that bin.
Multiplying through by N:

N*Distance(Px,Cx)=|N*Px−Sum(all x's)| (8)

Multiplying the original comparison (Equation 4) by N:

N*Distance(Px,Cx)≦N*dxMax (9)

Further, substituting Equation 8 into Equation 9 provides a result:

|N*Px−Sum(all x's)|≦N*dxMax (10)

Equation 10 is an example form of the x criteria that may be advantageously implemented in hardware. Sum(all x's) may denote the running sum of the x coordinates of all previous pixels that were accepted into that bin. For example, one multiplier may be used for the evaluation of Equation 10 for the N*Px term. For example, the N*dxMax term may avoid an explicit multiplier by maintaining a running sum of N*dxMax in the Accumulator Memory 526. For example, each Accumulator Memory slice may store the N*dxMax running sum, and each time a pixel is added to that bin, dxMax may be added to it. For example, the equations for y and z may be obtained similarly, so that an example evaluation of Equations 4-6 may involve a total of three multipliers per evaluation lane.

Since W evaluation lanes may be executing concurrently in the pipeline, each lane may first determine whether the candidate pixel could fall within its bin. Of those that pass all three distance checks, each may set a bit indicating that it would accept the pixel. Across all W bins, a priority encoder may determine the lowest numbered bin that has indicated acceptance, and the values for that bin may be updated in the Accumulator Memory 526.

For example, the information for each bin may include the number of pixels in the bin N, Sum(all x's), Sum(all y's), Sum(all z's), and the N*dxMax, N*dyMax & N*dzMax sums. For some parts, the weight of the pixels may be included in the centroid calculation, so the sum of the weights of all pixels in each bin is also kept, Sum(all wᵢ's). Likewise, when the weight is applied, Sum(all x's) may become the Sum(all (xᵢ*w)'s). Further, for some parts, a bonus may be applied when a particular pixel exceeds an extraordinarily high threshold. In these cases, for example, the coordinate contributions and weights of that pixel may be multiplied by 2 (shifted left by 1) before being added into the sums, and the number of pixels N may be incremented by 2.

In the event that no bins in a pixel/part/bin entry may accept a pixel, that entry may be dropped from the pipeline. When a pixel does not fall into an existing bin, but there is a new bin available, the new bin may appear at the end of the priority encoder chain within the pixel/part/bin entry and accept the pixel as normal.

After all pixels are processed through the pipeline, each of the Accumulator Memory bin entries may be read, and those containing pixels may be further processed for final output. For example, final divisions may be performed to calculate actual centroid coordinates. For example, Sum(all x's)/N, or Sum(all (xᵢ*wᵢ)'s)/Sum(all wᵢ's) may be performed in the event that weighting was used. Since these divisions occur once at the end, they may have a minimal impact on run-time, and they may be performed sequentially by bin using a slow, but small, shift and subtract divider.

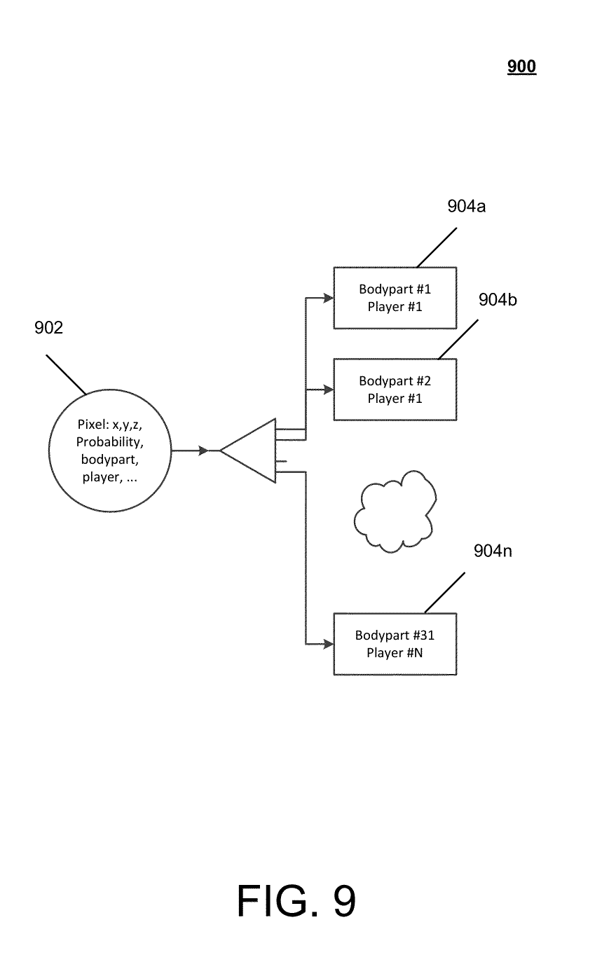

FIG. 9 illustrates an example architecture 900 for the system of FIG. 1. For example, as shown in FIG. 9, pixels 902 flow to a proper centroid unit 904a, 904b, . . . , 904n, depending on their tags (e.g., body part number and player number). As shown in FIG. 9, input to the architecture 900 may include pixel coordinates, a probability, body part indicators, player indicators (e.g., image data 114 of FIG. 1). As shown in FIG. 9, each centroid unit 904a, 904b, . . . , 904n may be associated with a predetermined body part of a particular player.

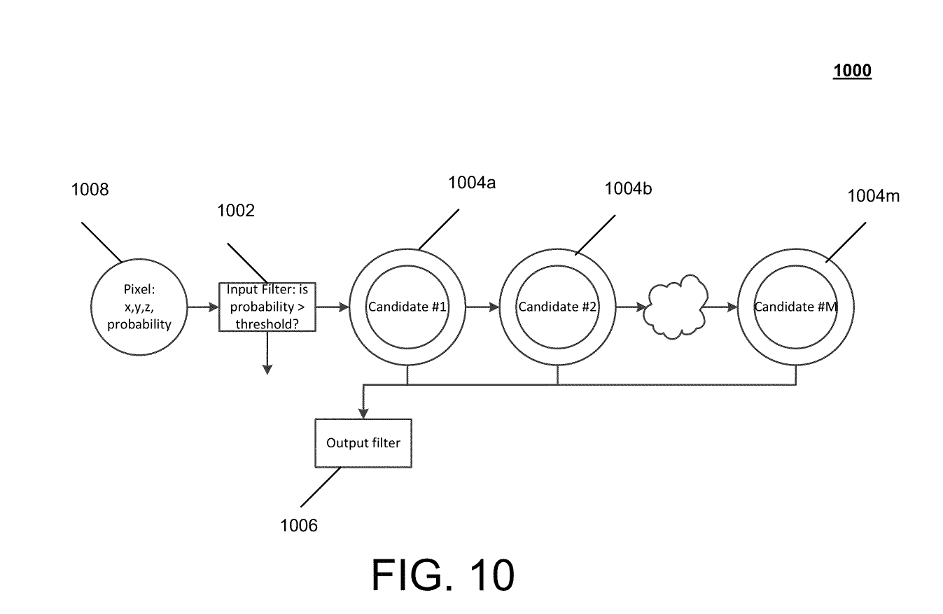

FIG. 10 illustrates an example array 1000 of candidate centroids (e.g., the array 142 of evaluation functions 144a, 144b, . . . , 144n of FIG. 1). For example, each centroid unit 1000 may include an input filter 1002, a number M of candidate centroids 1004a, 1004b, . . . , 1004m, and an output filter 1006, with an input pixel with probability 1008. Pixels 1008 are streamed through the candidate centroids 1004a, 1004b, . . . , 1004m, as discussed above. Results may be flown out to the output filter 1006 at the end of each frame, and the centroids 1004a, 1004b, . . . , 1004m may then be reset, as discussed above.

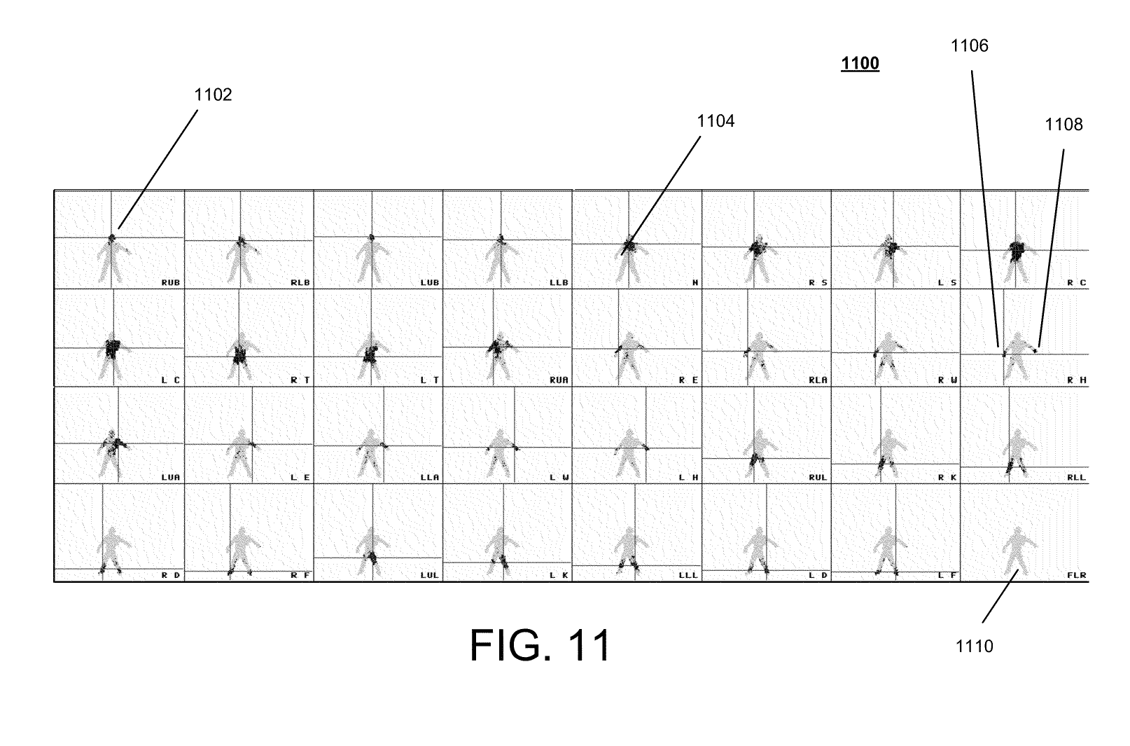

FIG. 11 illustrates an example input probability map 1100 (e.g., probability map 166 of FIG. 1) of a body part map corresponding to example body parts. For example, a head 1102, chest 1104, left hand 1106, and right hand 1008 are depicted. Cross-hairs illustrate “best centroids” in each illustrated box, and a box on the lower right of FIG. 11 illustrates an example silhouette 1110 of one example individual (e.g., a player).

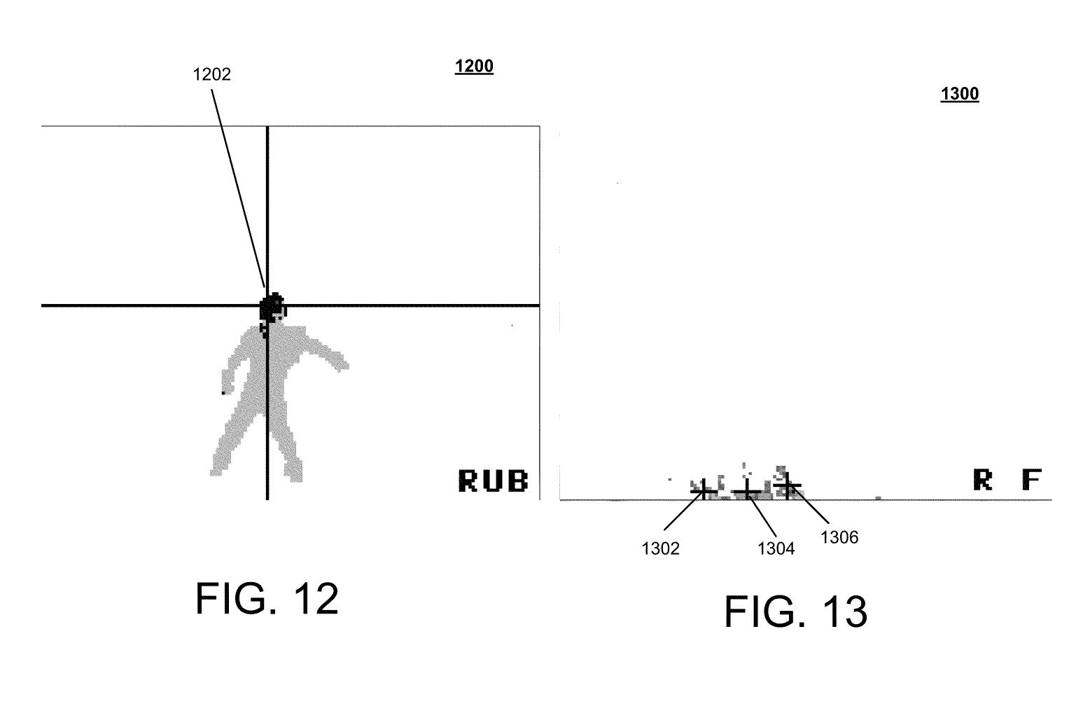

FIG. 12 illustrates an example representation 1200 of a body part map (e.g., right upper head part) for one player. Although not explicitly shown in FIG. 12, different colors may represent different probabilities assigned to each pixel. A cross-hair indicator 1202 may indicate a resulting top-scoring centroid.

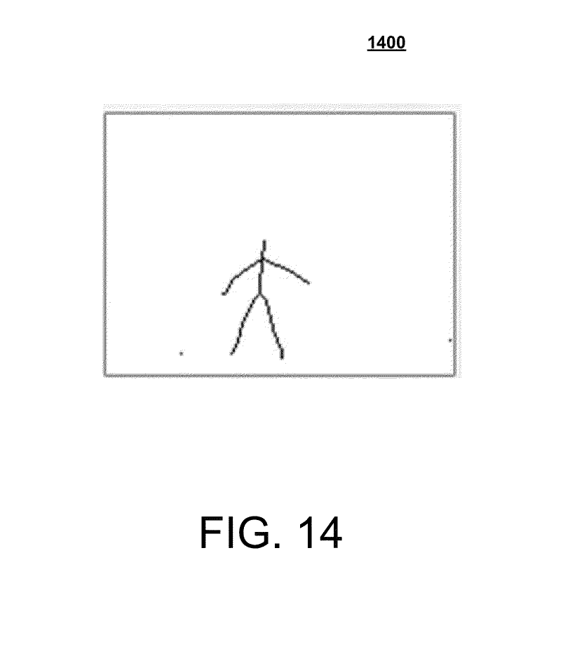

FIG. 13 illustrates an example result 1300 of noisy input, resulting in multiple candidate centroids 1302, 1304, 1306.

FIG. 14 illustrates an example result skeleton 1400 for an individual (e.g., player). For example, the skeleton 1400 may be generated by connecting the top-scoring centroids discussed above.

One skilled in the art of data processing will appreciate that many different techniques may be used for streamed k-means computations, without departing from the spirit of the discussion herein.

### III. Flowchart Description

Features discussed herein are provided as example embodiments that may be implemented in many different ways that may be understood by one of skill in the art of data processing, without departing from the spirit of the discussion herein. Such features are to be construed only as example embodiment features, and are not intended to be construed as limiting to only those detailed descriptions.

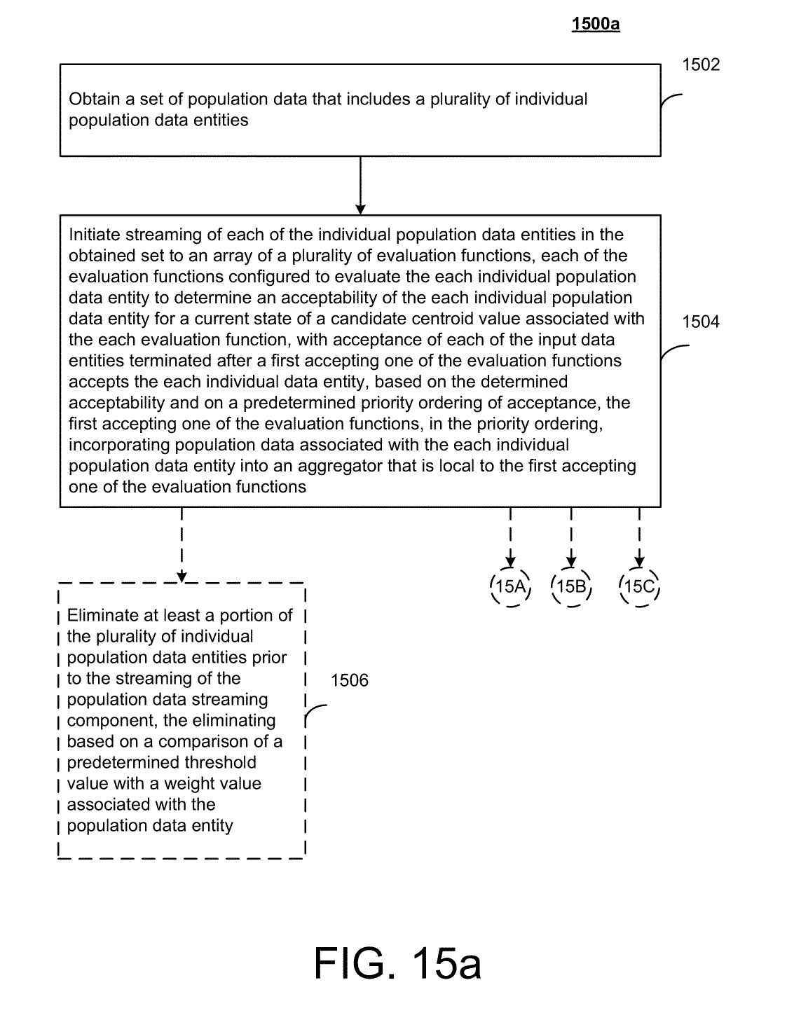

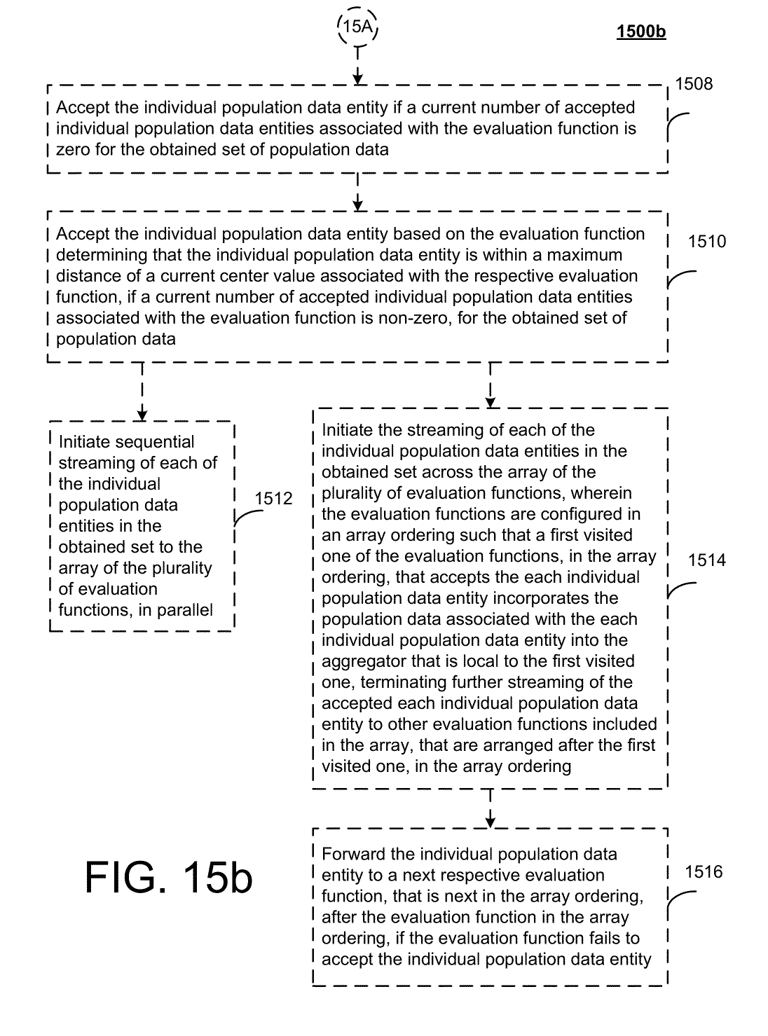

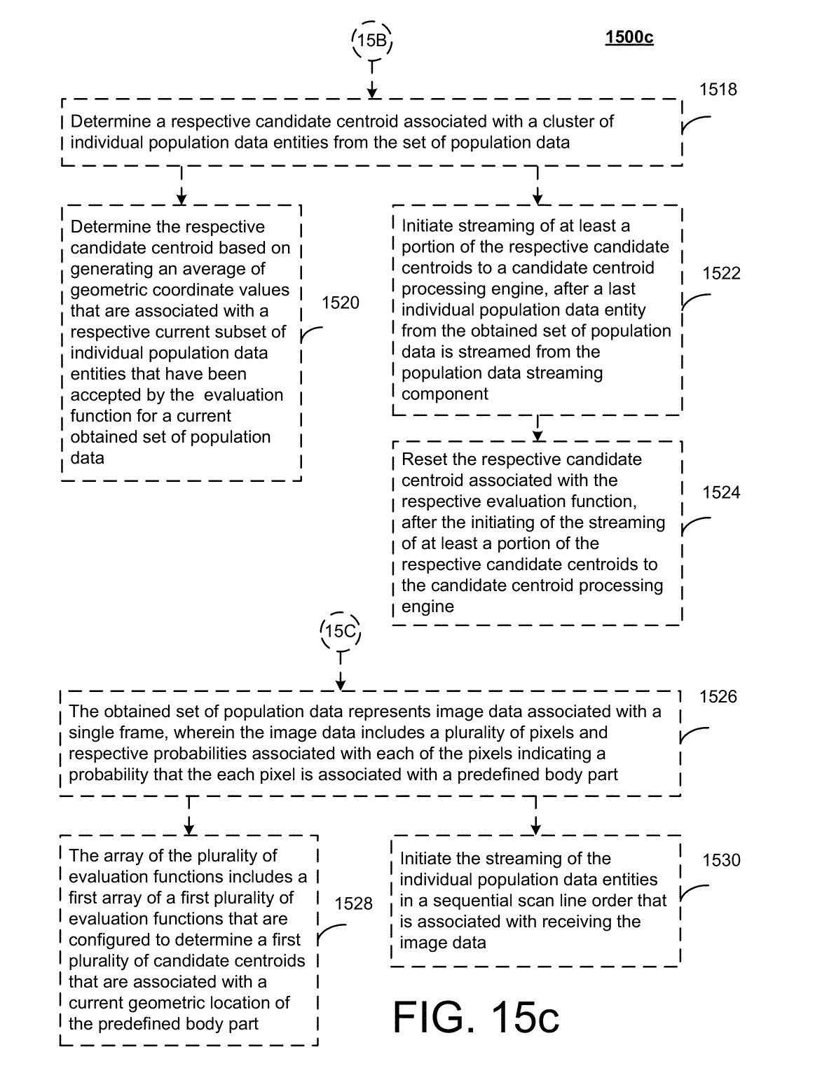

FIG. 15 is a flowchart illustrating example operations of the system of FIG. 1, according to example embodiments. In the example of FIG. 15a, a set of population data that includes a plurality of individual population data entities may be obtained (1502). For example, the population data acquisition component 108 may obtain the set of population data 110 that includes the plurality of individual population data entities 112a, 112b, . . . , 112m, as discussed above.

Streaming of each of the individual population data entities in the obtained set may be initiated, to an array of a plurality of evaluation functions, each of the evaluation functions configured to evaluate the individual population data entity to determine an acceptability of the individual population data entity for a current state of a candidate centroid value associated with the evaluation function, with acceptance of each of the input data entities terminated after a first accepting one of the evaluation functions accepts the each individual data entity, based on the determined acceptability and on a predetermined priority ordering of acceptance, the first accepting one of the evaluation functions, in the priority ordering, incorporating population data associated with the each individual population data entity into an aggregator that is local to the first accepting one of the evaluation functions (1504). For example, the population data streaming component 140 may initiate streaming of each of the individual population data entities 112a, 112b, . . . , 112m in the obtained set to an array 142 of a plurality of evaluation functions 144a, 144b, . . . , 144n, each of the evaluation functions 144a, 144b, . . . , 144n configured to evaluate the individual population data entity 112a, 112b, . . . , 112m to determine an acceptability of the each individual population data entity 112 for a current state of a candidate centroid value 160a, 160b, . . . , 160n associated with the each evaluation function 144a, 144b, . . . , 144n, with acceptance of each of the input data entities terminated after a first accepting one of the evaluation functions 144a, 144b, . . . , 144n accepts the individual data entity 112a, 112b, . . . , 112m, based on the determined acceptability and on a predetermined priority ordering 145 of acceptance, the first accepting one of the evaluation functions 144a, 144b, . . . , 144n, in the priority ordering 145, incorporating population data associated with the individual population data entity 112a, 112b, . . . , 112m into an aggregator 146a, 146b, . . . , 146n that is local to the first accepting one of the evaluation functions 144b, . . . , 144n, as discussed above.

For example, at least a portion of the plurality of individual population data entities may be eliminated prior to the streaming, the eliminating based on a comparison of a predetermined threshold value with a weight value associated with the population data entity (1506). For example, the input filter 150 may eliminate at least a portion of the plurality of individual population data entities 112a, 112b, . . . , 112m prior to the streaming of the population data streaming component 140, the eliminating based on a comparison of a predetermined threshold value 152 with a weight value associated with the population data entity 112a, 112b, . . . , 112m, as discussed above

For example, the individual population data entity may be accepted if a current number of accepted individual population data entities associated with the each of the evaluation functions is zero for the obtained set of population data (1508), in the example of FIG. 15b. For example, the each individual population data entity may be accepted based on the each evaluation function determining that the each individual population data entity is within a maximum distance of a current center value associated with the respective each evaluation function, if a current number of accepted individual population data entities associated with the each of the evaluation functions is non-zero, for the obtained set of population data (1510). For example, each of the evaluation functions 144a, 144b, . . . , 144n may be configured to accept the each individual population data entity 112a, 112b, . . . , 112m if a current number 154 of accepted individual population data entities 112a, 112b, . . . , 112m associated with the each of the evaluation functions 144a, 144b, . . . , 144n is zero for the obtained set of population data. For example, each of the evaluation functions 144a, 144b, . . . , 144n may accept the each individual population data entity 112a, 112b, . . . , 112m based on the each evaluation function 144a, 144b, . . . , 144n determining that the each individual population data entity 112a, 112b, . . . , 112m is within a maximum distance 156 of a current center value 158 associated with the respective each evaluation function 144a, 144b, . . . , 144n, if a current number 154 of accepted individual population data entities 112a, 112b, . . . , 112m associated with the each of the evaluation functions 144a, 144b, . . . , 144n is non-zero, for the obtained set of population data 110, as discussed above.

For example, sequential streaming may be initiated, of each of the individual population data entities in the obtained set to the array of the plurality of evaluation functions, in parallel (1512). For example, the population data streaming component 140 may initiate sequential streaming of each of the individual population data entities 112a, 112b, . . . , 112m in the obtained set to the array 142 of a plurality of evaluation functions 144a, 144b, . . . , 144n, in parallel, as discussed above.

For example, the streaming of each of the individual population data entities in the obtained set may be initiated, across the array of the plurality of evaluation functions, wherein the evaluation functions are configured in an array ordering such that a first visited one of the evaluation functions, in the array ordering, that accepts the each individual population data entity incorporates the population data associated with the each individual population data entity into the aggregator that is local to the first visited one, terminating further streaming of the accepted each individual population data entity to other evaluation functions included in the array, that are arranged after the first visited one, in the array ordering (1514). For example, the population data streaming component 140 may initiate sequential streaming of each of the individual population data entities 112a, 112b, . . . , 112m in the obtained set to the array 142 of a plurality of evaluation functions 144a, 144b, . . . , 144n, wherein the plurality of evaluation functions 144a, 144b, . . . , 144n are configured in an array ordering such that a first visited one of the evaluation functions 144a, 144b, . . . , 144n, in the array ordering, that accepts the each individual population data entity 112a, 112b, . . . , 112m incorporates the population data associated with the each individual population data entity 112a, 112b, . . . , 112m into the aggregator 146a, 146b, . . . , 146n that is local to the first visited one, terminating further streaming of the accepted each individual population data entity 112a, 112b, . . . , 112m to other evaluation functions 144a, 144b, . . . , 144n included in the array 142, that are arranged after the first visited one, in the array ordering, as discussed above.

For example, the individual population data entity may be forwarded to a next respective evaluation function, that is next in the array ordering, after the each evaluation function in the array ordering, if the each evaluation function fails to accept the each individual population data entity (1516). For example, each of the evaluation functions 144a, 144b, . . . , 144n may forward the each individual population data entity 112a, 112b, . . . , 112m to a next respective evaluation function 144a, 144b, . . . , 144n, that is next in the array ordering, after the each evaluation function 144a, 144b, . . . , 144n in the array ordering, if the each evaluation function 144a, 144b, . . . , 144n fails to accept the each individual population data entity 112a, 112b, . . . , 112m, as discussed above.

For example, a respective candidate centroid associated with a cluster of individual population data entities from the set of population data may be determined (1518), in the example of FIG. 15c. For example, each of the evaluation functions 144a, 144b, . . . , 144n may be configured to determine a respective candidate centroid 160a, 160b, . . . , 160n associated with a cluster of individual population data entities 112a, 112b, . . . , 112m from the set of population data 110, as discussed above.

For example, the respective candidate centroid may be determined based on generating an average of geometric coordinate values that are associated with a respective current subset of individual population data entities that have been accepted by the each evaluation function for a current obtained set of population data (1520). For example, each of the evaluation functions 144a, 144b, . . . , 144n may be configured to determine the respective candidate centroid 160a, 160b, . . . , 160n based on generating an average of geometric coordinate values 162 that are associated with a respective current subset of individual population data entities 112a, 112b, . . . , 112m that have been accepted by the each evaluation function 144a, 144b, . . . , 144n for a current obtained set of population data 110, as discussed above. For example, accumulative results of the respective aggregators that are local to the respective evaluation functions in the array may approximate k-means clustering of the population data using single pass streaming over the population data.

For example, streaming of at least a portion of the respective candidate centroids to a candidate centroid processing engine may be initiated, after a last individual population data entity from the obtained set of population data is streamed from the population data streaming component (1522). For example, the plurality of evaluation functions 144a, 144b, . . . , 144n may initiate streaming of at least a portion of the respective candidate centroids 160a, 160b, . . . , 160n to a candidate centroid processing engine 164, after a last individual population data entity 112a, 112b, . . . , 112m from the obtained set of population data 110 is streamed from the population data streaming component 140, as discussed above.

For example, the respective candidate centroid associated with the respective each evaluation function may be reset, after the initiating of the streaming of at least a portion of the respective candidate centroids to the candidate centroid processing engine (1524). For example, each of the evaluation functions 144a, 144b, . . . , 144n may reset the respective candidate centroid 160a, 160b, . . . , 160n associated with the respective each evaluation function 144a, 144b, . . . , 144n, after the initiating of the streaming of at least a portion of the respective candidate centroids 160a, 160b, . . . , 160n to the candidate centroid processing engine 164, as discussed above.

For example, the obtained set of population data may represent image data associated with a single frame, wherein the image data includes a plurality of pixels and respective probabilities associated with each of the pixels indicating a probability that the each pixel is associated with a predefined body part (1526).

For example, the array of the plurality of evaluation functions may include a first array of a first plurality of evaluation functions that are configured to determine a first plurality of candidate centroids that are associated with a current geometric location of the predefined body part (1528).

For example, the streaming of the each of the individual population data entities may be initiated in a sequential scan line order that is associated with receiving the image data (1530).

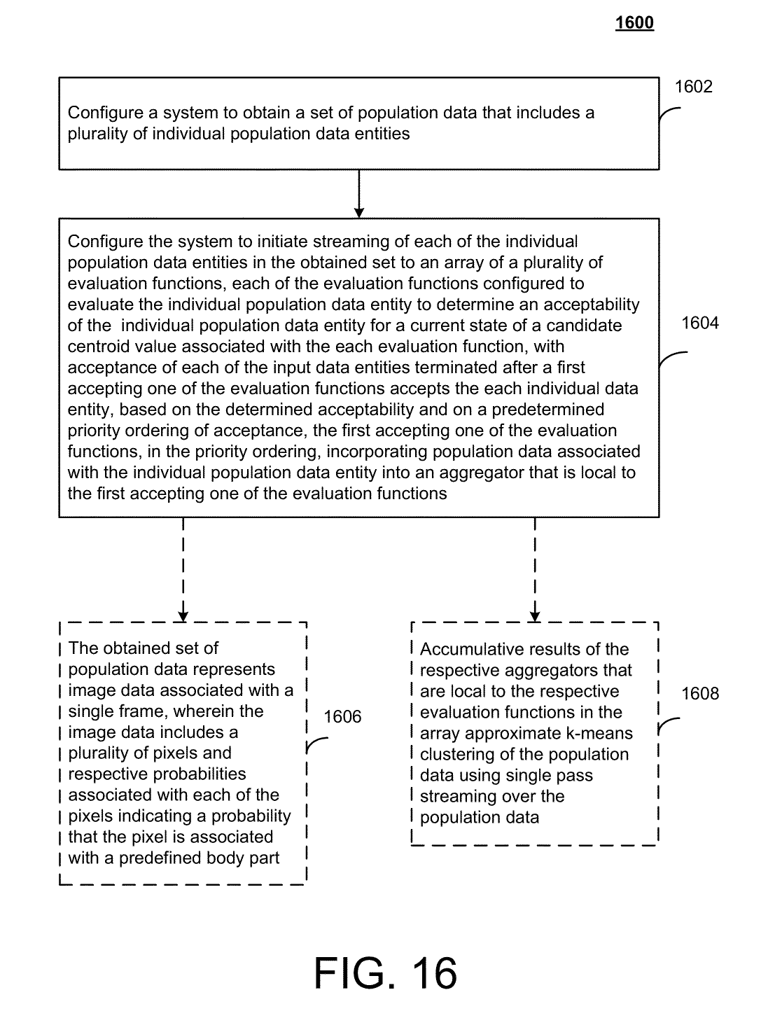

FIG. 16 is a flowchart illustrating example operations associated with the system of FIG. 1, according to example embodiments. In the example of FIG. 16, a system to obtain a set of population data that includes a plurality of individual population data entities may be configured (1602).

The system may be configured to initiate streaming of each of the individual population data entities in the obtained set to an array of a plurality of evaluation functions, each of the evaluation functions configured to evaluate the each individual population data entity to determine an acceptability of the each individual population data entity for a current state of a candidate centroid value associated with the each evaluation function, with acceptance of each of the input data entities terminated after a first accepting one of the evaluation functions accepts the each individual data entity, based on the determined acceptability and on a predetermined priority ordering of acceptance, the first accepting one of the evaluation functions, in the priority ordering, incorporating population data associated with the each individual population data entity into an aggregator that is local to the first accepting one of the evaluation functions (1604). For example, the data streaming component 140 may initiate streaming of each of the individual population data entities 112a, 112b, . . . , 112m in the obtained set to an array 142 of a plurality of evaluation functions 144a, 144b, . . . , 144n, each of the evaluation functions 144a, 144b, . . . , 144n configured to evaluate the individual population data entity 112a, 112b, . . . , 112m to determine an acceptability of the each individual population data entity 112 for a current state of a candidate centroid value 160a, 160b, . . . , 160n associated with the each evaluation function 144a, 144b, . . . , 144n, with acceptance of each of the input data entities terminated after a first accepting one of the evaluation functions 144a, 144b, . . . , 144n accepts the individual data entity 112a, 112b, . . . , 112m, based on the determined acceptability and on a predetermined priority ordering 145 of acceptance, the first accepting one of the evaluation functions 144a, 144b, . . . , 144n, in the priority ordering 145, incorporating population data associated with the individual population data entity 112a, 112b, . . . , 112m into an aggregator 146a, 146b, . . . , 146n that is local to the first accepting one of the evaluation functions 144b, . . . , 144n, as discussed above.

For example, the obtained set of population data may represent image data associated with a single frame, wherein the image data includes a plurality of pixels and respective probabilities associated with each of the pixels indicating a probability that the each pixel is associated with a predefined body part (1606).

For example, accumulative results of the respective aggregators that are local to the respective evaluation functions in the array may approximate k-means clustering of the population data using single pass streaming over the population data (1608).

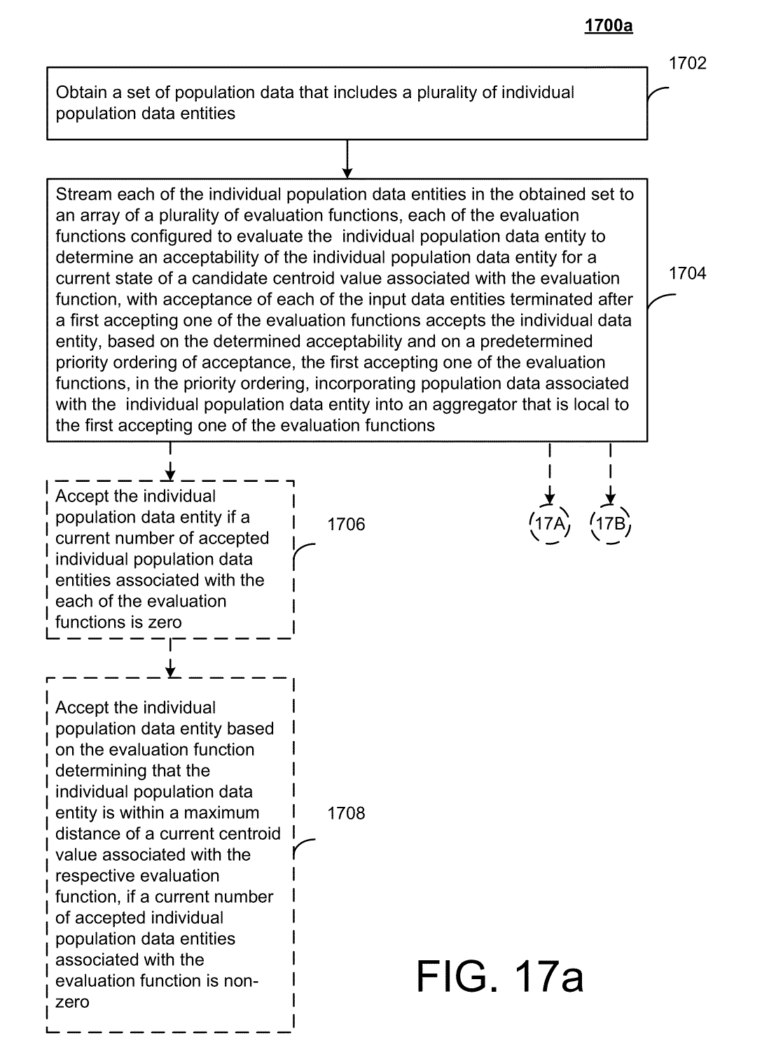

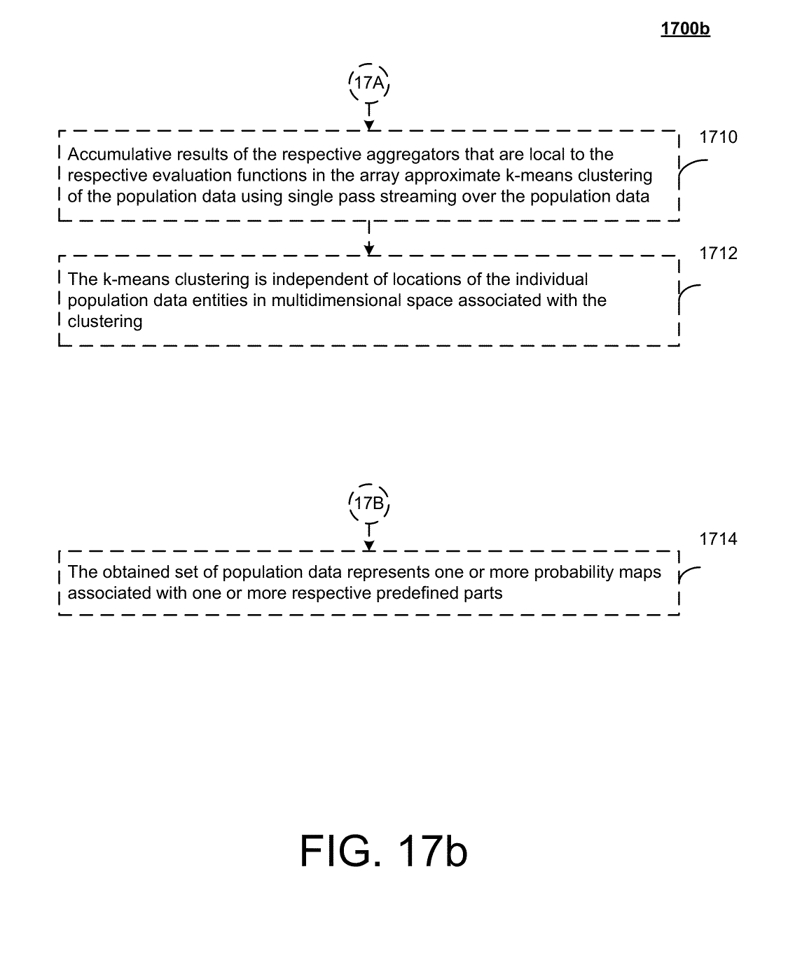

FIG. 17 is a flowchart illustrating example operations of the system of FIG. 1, according to example embodiments. In the example of FIG. 17a, a set of population data that includes a plurality of individual population data entities may be obtained (1702). For example, the population data acquisition component 108 may obtain a set of population data 110 that includes a plurality of individual population data entities 112a, 112b, . . . , 112m, as discussed above.

Each of the individual population data entities in the obtained set may be streamed to an array of a plurality of evaluation functions, each of the evaluation functions configured to evaluate the each individual population data entity to determine an acceptability of the each individual population data entity for a current state of a candidate centroid value associated with the each evaluation function, with acceptance of each of the input data entities terminated after a first accepting one of the evaluation functions accepts the each individual data entity, based on the determined acceptability and on a predetermined priority ordering of acceptance, the first accepting one of the evaluation functions, in the priority ordering, incorporating population data associated with the each individual population data entity into an aggregator that is local to the first accepting one of the evaluation functions (1704). For example, the data streaming component 140 may initiate streaming of each of the individual population data entities 112a, 112b, . . . , 112m in the obtained set to an array 142 of a plurality of evaluation functions 144a, 144b, . . . , 144n, each of the evaluation functions 144a, 144b, . . . , 144n configured to evaluate the individual population data entity 112a, 112b, . . . , 112m to determine an acceptability of the each individual population data entity 112 for a current state of a candidate centroid value 160a, 160b, . . . , 160n associated with the each evaluation function 144a, 144b, . . . , 144n, with acceptance of each of the input data entities terminated after a first accepting one of the evaluation functions 144a, 144b, . . . , 144n accepts the individual data entity 112a, 112b, . . . , 112m, based on the determined acceptability and on a predetermined priority ordering 145 of acceptance, the first accepting one of the evaluation functions 144a, 144b, . . . , 144n, in the priority ordering 145, incorporating population data associated with the individual population data entity 112a, 112b, . . . , 112m into an aggregator 146a, 146b, . . . , 146n that is local to the first accepting one of the evaluation functions 144b, . . . , 144n, as discussed above.

For example, the individual population data entity may be accepted if a current number of accepted individual population data entities associated with the each of the evaluation functions is zero (1706). For example, the each individual population data entity may be accepted based on the each evaluation function determining that the each individual population data entity is within a maximum distance of a current centroid value associated with the respective each evaluation function, if a current number of accepted individual population data entities associated with the each of the evaluation functions is non-zero (1708). For example, each of the evaluation functions 144a, 144b, . . . , 144n may be configured to accept the each individual population data entity 112a, 112b, . . . , 112m if a current number 154 of accepted individual population data entities 112a, 112b, . . . , 112m associated with the each of the evaluation functions 144a, 144b, . . . , 144n is zero for the obtained set of population data. For example, each of the evaluation functions 144a, 144b, . . . , 144n may accept the each individual population data entity 112a, 112b, . . . , 112m based on the each evaluation function 144a, 144b, . . . , 144n determining that the each individual population data entity 112a, 112b, . . . , 112m is within a maximum distance 156 of a current center value 158 associated with the respective each evaluation function 144a, 144b, . . . , 144n, if a current number 154 of accepted individual population data entities 112a, 112b, . . . , 112m associated with the each of the evaluation functions 144a, 144b, . . . , 144n is non-zero, for the obtained set of population data 110, as discussed above.

For example, accumulative results of the respective aggregators that are local to the respective evaluation functions in the array may approximate k-means clustering of the population data using single pass streaming over the population data (1710), in the example of FIG. 17b.

For example, the k-means clustering is independent of locations of the individual population data entities in multidimensional space associated with the clustering (1712).

For example, the obtained set of population data may represent one or more probability maps associated with one or more respective predefined parts (1714).

One skilled in the art of data processing will understand that there may be many ways of performing streamed k-means computations, without departing from the spirit of the discussion herein.

Example techniques discussed herein may be used for any type of input that may be evaluated based on cluster analysis (e.g., with massive input, rapid response desired). For example, real-time trades of commodities may be analyzed using example techniques discussed herein, as well as image data for moving objects.

Customer privacy and confidentiality have been ongoing considerations in data processing environments for many years. Thus, example techniques for streaming computations may use user input and/or data provided by users who have provided permission via one or more subscription agreements (e.g., “Terms of Service” (TOS) agreements) with associated applications or services associated with such computations. For example, users may provide consent to have their input/data transmitted and stored on devices, though it may be explicitly indicated (e.g., via a user accepted agreement) that each party may control how transmission and/or storage occurs, and what level or duration of storage may be maintained, if any.

Implementations of the various techniques described herein may be implemented in digital electronic circuitry, or in computer hardware, firmware, software, or in combinations of them (e.g., an apparatus configured to execute instructions to perform various functionality).

Implementations may be implemented as a computer program embodied in a pure signal such as a pure propagated signal. Such implementations may be referred to herein as implemented via a “computer-readable transmission medium.”

Alternatively, implementations may be implemented as a computer program embodied in a machine usable or machine readable storage device (e.g., a magnetic or digital medium such as a Universal Serial Bus (USB) storage device, a tape, hard disk drive, compact disk, digital video disk (DVD), etc.), for execution by, or to control the operation of, data processing apparatus, e.g., a programmable processor, a computer, or multiple computers. Such implementations may be referred to herein as implemented via a “computer-readable storage medium” or a “computer-readable storage device” and are thus different from implementations that are purely signals such as pure propagated signals.

A computer program, such as the computer program(s) described above, can be written in any form of programming language, including compiled, interpreted, or machine languages, and can be deployed in any form, including as a stand-alone program or as a module, component, subroutine, or other unit suitable for use in a computing environment. The computer program may be tangibly embodied as executable code (e.g., executable instructions) on a machine usable or machine readable storage device (e.g., a computer-readable medium). A computer program that might implement the techniques discussed above may be deployed to be executed on one computer or on multiple computers at one site or distributed across multiple sites and interconnected by a communication network.

Method steps may be performed by one or more programmable processors executing a computer program to perform functions by operating on input data and generating output. The one or more programmable processors may execute instructions in parallel, and/or may be arranged in a distributed configuration for distributed processing. Example functionality discussed herein may also be performed by, and an apparatus may be implemented, at least in part, as one or more hardware logic components. For example, and without limitation, illustrative types of hardware logic components that may be used may include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Processors suitable for the execution of a computer program include, by way of example, both general and special purpose microprocessors, and any one or more processors of any kind of digital computer. Generally, a processor will receive instructions and data from a read only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto optical disks, or optical disks. Information carriers suitable for embodying computer program instructions and data include all forms of nonvolatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT), liquid crystal display (LCD), or plasma monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback. For example, output may be provided via any form of sensory output, including (but not limited to) visual output (e.g., visual gestures, video output), audio output (e.g., voice, device sounds), tactile output (e.g., touch, device movement), temperature, odor, etc.

Further, input from the user can be received in any form, including acoustic, speech, or tactile input. For example, input may be received from the user via any form of sensory input, including (but not limited to) visual input (e.g., gestures, video input), audio input (e.g., voice, device sounds), tactile input (e.g., touch, device movement), temperature, odor, etc.

Further, a natural user interface (NUI) may be used to interface with a user. In this context, a “NUI” may refer to any interface technology that enables a user to interact with a device in a “natural” manner, free from artificial constraints imposed by input devices such as mice, keyboards, remote controls, and the like.

Examples of NUI techniques may include those relying on speech recognition, touch and stylus recognition, gesture recognition both on a screen and adjacent to the screen, air gestures, head and eye tracking, voice and speech, vision, touch, gestures, and machine intelligence. Example NUI technologies may include, but are not limited to, touch sensitive displays, voice and speech recognition, intention and goal understanding, motion gesture detection using depth cameras (e.g., stereoscopic camera systems, infrared camera systems, RGB (red, green, blue) camera systems and combinations of these), motion gesture detection using accelerometers/gyroscopes, facial recognition, 3D displays, head, eye, and gaze tracking, immersive augmented reality and virtual reality systems, all of which may provide a more natural interface, and technologies for sensing brain activity using electric field sensing electrodes (e.g., electroencephalography (EEG) and related techniques).

Implementations may be implemented in a computing system that includes a back end component, e.g., as a data server, or that includes a middleware component, e.g., an application server, or that includes a front end component, e.g., a client computer having a graphical user interface or a Web browser through which a user can interact with an implementation, or any combination of such back end, middleware, or front end components. Components may be interconnected by any form or medium of digital data communication, e.g., a communication network. Examples of communication networks include a local area network (LAN) and a wide area network (WAN), e.g., the Internet.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A system comprising:
a device that includes at least one processor, the device including a streaming computational engine comprising instructions tangibly embodied on a computer readable storage medium for execution by the at least one processor, the streaming computational engine including:
a population data acquisition component configured to obtain a set of population data that includes a plurality of individual population data entities; and
a population data streaming component configured to initiate streaming of each of the individual population data entities in the obtained set to an array of a plurality of evaluation functions, each of the evaluation functions configured to evaluate the each individual population data entity to determine an acceptability of the each individual population data entity for a current state of a candidate centroid value associated with the each evaluation function, with acceptance of each of the input data entities terminated after a first accepting one of the evaluation functions accepts the each individual data entity, based on the determined acceptability and on a predetermined priority ordering of acceptance, the first accepting one of the evaluation functions, in the priority ordering, incorporating population data associated with the each individual population data entity into an aggregator that is local to the first accepting one of the evaluation functions.

2. The system of claim 1, further comprising:
an input filter configured to eliminate at least a portion of the plurality of individual population data entities prior to the streaming of the population data streaming component, the eliminating based on a comparison of a predetermined threshold value with a weight value associated with the population data entity.

3. The system of claim 1, wherein:
each of the evaluation functions is configured to:
accept the each individual population data entity if a current number of accepted individual population data entities associated with the each of the evaluation functions is zero for the obtained set of population data, or
accept the each individual population data entity based on the each evaluation function determining that the each individual population data entity is within a maximum distance of a current center value associated with the respective each evaluation function, if a current number of accepted individual population data entities associated with the each of the evaluation functions is non-zero, for the obtained set of population data.

4. The system of claim 3, wherein:
the population data streaming component is configured to initiate sequential streaming of each of the individual population data entities in the obtained set to the array of the plurality of evaluation functions, in parallel.

5. The system of claim 3, wherein:
the population data streaming component is configured to initiate the streaming of each of the individual population data entities in the obtained set across the array of the plurality of evaluation functions, wherein the evaluation functions are configured in an array ordering such that a first visited one of the evaluation functions, in the array ordering, that accepts the each individual population data entity incorporates the population data associated with the each individual population data entity into the aggregator that is local to the first visited one, terminating further streaming of the accepted each individual population data entity to other evaluation functions included in the array, that are arranged after the first visited one, in the array ordering.

6. The system of claim 5, wherein:
each of the evaluation functions is configured to forward the each individual population data entity to a next respective evaluation function, that is next in the array ordering, after the each evaluation function in the array ordering, if the each evaluation function fails to accept the each individual population data entity.

7. The system of claim 1, wherein:
each of the evaluation functions is configured to determine a respective candidate centroid associated with a cluster of individual population data entities from the set of population data.

8. The system of claim 7, wherein:
each of the evaluation functions is configured to determine the respective candidate centroid based on generating an average of geometric coordinate values that are associated with a respective current subset of individual population data entities that have been accepted by the each evaluation function for a current obtained set of population data.

9. The system of claim 7, wherein:
the plurality of evaluation functions is configured to initiate streaming of at least a portion of the respective candidate centroids to a candidate centroid processing engine, after a last individual population data entity from the obtained set of population data is streamed from the population data streaming component.

10. The system of claim 9, wherein:
each of the evaluation functions is configured to reset the respective candidate centroid associated with the respective each evaluation function, after the initiating of the streaming of at least a portion of the respective candidate centroids to the candidate centroid processing engine.

11. The system of claim 1, wherein:
the obtained set of population data represents image data associated with a single frame, wherein the image data includes a plurality of pixels and respective probabilities associated with each of the pixels indicating a probability that the each pixel is associated with a predefined body part.

12. The system of claim 11, wherein:
the array of the plurality of evaluation functions includes a first array of a first plurality of evaluation functions that are configured to determine a first plurality of candidate centroids that are associated with a current geometric location of the predefined body part.

13. The system of claim 11, wherein:
the population data streaming component is configured to initiate the streaming of the each of the individual population data entities in a sequential scan line order that is associated with receiving the image data.

14. A method comprising:
configuring a system to obtain a set of population data that includes a plurality of individual population data entities; and
configuring the system to initiate streaming of each of the individual population data entities in the obtained set to an array of a plurality of evaluation functions, each of the evaluation functions configured to evaluate the each individual population data entity to determine an acceptability of the each individual population data entity for a current state of a candidate centroid value associated with the each evaluation function, with acceptance of each of the input data entities terminated after a first accepting one of the evaluation functions accepts the each individual data entity, based on the determined acceptability and on a predetermined priority ordering of acceptance, the first accepting one of the evaluation functions, in the priority ordering, incorporating population data associated with the each individual population data entity into an aggregator that is local to the first accepting one of the evaluation functions.

15. The method of claim 14, wherein:
the obtained set of population data represents image data associated with a single frame, wherein the image data includes a plurality of pixels and respective probabilities associated with each of the pixels indicating a probability that the each pixel is associated with a predefined body part.

16. The method of claim 14, wherein:
accumulative results of the respective aggregators that are local to the respective evaluation functions in the array approximate k-means clustering of the population data using single pass streaming over the population data.

17. A computer-readable storage medium storing instructions that, when executed by one or more processors, cause the one or more processors to:
obtain a set of population data that includes a plurality of individual population data entities; and
stream each of the individual population data entities in the obtained set to an array of a plurality of evaluation functions, each of the evaluation functions configured to evaluate the each individual population data entity to determine an acceptability of the each individual population data entity for a current state of a candidate centroid value associated with the each evaluation function, with acceptance of each of the input data entities terminated after a first accepting one of the evaluation functions accepts the each individual data entity, based on the determined acceptability and on a predetermined priority ordering of acceptance, the first accepting one of the evaluation functions, in the priority ordering, incorporating population data associated with the each individual population data entity into an aggregator that is local to the first accepting one of the evaluation functions.

18. The computer-readable storage medium of claim 17, wherein:
each of the evaluation functions is configured to:
accept the each individual population data entity if a current number of accepted individual population data entities associated with the each of the evaluation functions is zero, or
accept the each individual population data entity based on the each evaluation function determining that the each individual population data entity is within a maximum distance of a current centroid value associated with the respective each evaluation function, if a current number of accepted individual population data entities associated with the each of the evaluation functions is non-zero.

19. The computer-readable storage medium of claim 17, wherein:
accumulative results of the respective aggregators that are local to the respective evaluation functions in the array approximate k-means clustering of the population data using single pass streaming over the population data, wherein the k-means clustering is independent of locations of the individual population data entities in multidimensional space associated with the clustering.

20. The computer-readable storage medium of claim 17, wherein:
the obtained set of population data represents one or more probability maps associated with one or more respective predefined parts.
